(19) United States
(12) Patent Application Publication
(10) Pub. No.: US 2013/0100398 A1
(43) Pub. Date: Apr. 25, 2013

(54) PROGRESSIVE ADDITION LENS

(71) Applicants: Anna Ryndin, Haifa (IL); Abraham Lisichki, Haifa (IL)

(72) Inventors: Anna Ryndin, Haifa (IL); Abraham Lisichki, Haifa (IL)

(73) Assignee: A-2 Vision Technologies, Migdal HaEmek (IL)

(21) Appl. No.: 13/807,946

(22) PCT Filed: Jun. 13, 2011
(86) PCT No.: PCT/IL11/00471

§ 371 Date: Jan. 2, 2013

Related U.S. Application Data
(60) Provisional application No. 61/361,441, filed on Jul. 5, 2010.

(51) Int. Cl. G02C 7/06

(52) U.S. Cl. CPC G02C 7/061
USPC 351/159.42; 425/500

(57) ABSTRACT

A progressive addition lens device is disclosed. The device comprises a lens body formed with a progressive power surface having a temporal part and a nasal part. The surface is characterized by an optical power map having a plurality of contours corresponding to transitions between optical powers across the surface, wherein at least 70% of the contours are substantially monotonic at the temporal part.

### RELATED APPLICATION/S

This application claims the benefit of priority from U.S. Application No. 61/361,441, filed on Jul. 5, 2010, the contents of which are incorporated by reference as if fully set forth herein.

### FIELD AND BACKGROUND OF THE INVENTION

The present invention, in some embodiments thereof, relates to optics and, more particularly, but not exclusively, to a progressive addition lens and methods for designing and/or manufacturing a progressive addition lens.

The optical power of an ophthalmic lens is defined as the reciprocal of its focal length, and is typically expressed in diopters, with negative and positive diopter values signifying eyes with myopia (nearsightedness) and hyperopia (farsightedness), respectively.

Use of ophthalmic lenses for the correction of ametropia is well known.

Generally, ophthalmic lenses are categorized as monofocal lenses, in which the optical power is uniform across the surface of the lens, and multifocal lenses which include two or more surface zones differing in their optical power. The latter are typically suitable for ameliorating presbyopia, which is a condition in which the accommodation ability of the eye is decreased or lost, typically with advancing age or after lens replacement, as in cataract surgery.

The original multifocal ophthalmic lenses intended for the correction of presbyopia were bifocals with a far-viewing zone in the carrier lens and a near-viewing zone embedded in the lower portion of the carrier lens. Modern multifocal ophthalmic lens have continuously variable optical power across their surfaces.

Of particular interest is the so called “progressive addition lens” (PAL) which includes a progressive surface attempting to provide far, intermediate, and near vision, in a gradual continuous progression of vertically increasing optical power from far to near focus. PALs are appealing to the wearer because they are free of the visual discontinuities caused by ledges between the zones of differing optical power that are found in other multifocal lenses, such as bifocals and trifocals.

In principle, a PAL includes a far-viewing zone through which the wearer views distant scenes, a near-viewing zone through which the wearer views nearby scenes, and a transition corridor which extends from the far-viewing zone to the near-viewing zone and through which the wearer views intermediate scenes. A PAL is commonly described by reference to the so-called “main meridian” (also known as “central” or “umbilical” line) which is an imaginary line running from above to below substantially in the middle of the lens surfaces in the state of wear. The optical power in the transition corridor is gradually increased along the main meridian from a minimal add power at the far-viewing zone to a maximal add power at the near-viewing zone.

In addition to the optical power, a lens is also characterized by a cylinder value which measures the deviation from sphericity of a particular part of the lens's surface. The term “cylinder” is originated from cylindrical lenses which inherently have different foci lengths in different direction. The optical effect caused by a lens having a non-zero cylinder value is known as surface astigmatism. In optometry nomenclature, the term “astigmatism” is also used to describe a physiological defect, for example, when the cornea has an irregular curvature. For wearers whose ametropia includes astigmatism, a certain cylinder value in the lens is desired since it corrects the eye's astigmatism. However, unwanted cylinder value (either not properly adjusted for the astigmatism of the eye, or being present for a non-astigmatic eye) or varying across the field of view creates areas of blur and distortion within the field-of-view.

Two design types for PAL are known in the art. A first type, referred to in the literature as “hard design,” is a design having relatively wide far and reading zones. In this design, the unwanted cylinder value is more pronounced on either side of the transition corridor. A second design, referred to in the literature as “soft design,” is a design in which the unwanted cylinder value is spread over wider area, typically extending into the lateral portions of the far-viewing zone. For a given optical add power, the magnitude of the unwanted cylinder value of a hard design is greater than that of a soft design because the unwanted cylinder value of the soft design is distributed over a wider area of the lens.

Numerous PALs and PAL design techniques have been developed over the years, to this end see, e.g., U.S. Pat. Nos. 5,691,798, 5,805,265 and U.S. Published Application Nos. 20070030445 and 20070216863. Generally, in these techniques the PALs are designed such that the equi-astigmatic lines are distributed symmetrically about the main meridian, and the distribution of optical power is selected so as to maintain this symmetry as much as possible.

### SUMMARY OF THE INVENTION

Some embodiments of the present invention are concerned with a progressive addition lens (PAL). The PAL can be characterized by an optical power map which is a contour map wherein all points having the same optical power lay on a same contour and points between the contours have intermediate values of optical power. The PAL according to some of the embodiments has an optical power map which is substantially asymmetric with respect to the main meridian of the lens. Thus, the nasal and temporal parts of the PAL are substantially different.

At the temporal part of the lens, all contours above a horizontal line passing 15 mm below the 0-180 line of the lens are substantially monotonic. At the nasal part of the lens, at least some contours above the horizontal line are non-monotonic.

Various terms used herein, such as “main meridian,” “0-180 line,” and “monotonic contour” are defined hereinbelow.

In some embodiments of the present invention at least 70% or at least 75% or at least 80% of the contours in the optical power map are substantially monotonic at the temporal part of the lens. In some embodiments, at least 50% of the contours are non-monotonic at the nasal part. In various exemplary embodiments of the invention there is an angular span of at least 100 degrees or at least 120 degrees or at least 140 degrees within the temporal part of the lens for which all the contours are substantially monotonic. In some embodiments of the present invention the angular span for which all the contours are substantially monotonic at the nasal part is of less than 40 degrees or less than 30 degrees of less than 20 degrees.

Quantitatively, the asymmetry of the optical power map of the present embodiments can be expressed as a matrix of entries, wherein each entry represents a difference in optical powers for an antipodal pair of points. This matrix is referred to hereinbelow as an “asymmetry matrix.”

The value of each matrix entry depends on the base curve value and optical add value of the lens. Preferably, however, for any base curve value and optical add value there is at least one entry, and, more preferably at least a few entries, which is above one third or above one half of the optical add power of the lens. Namely, the optical map of the lens preferably has at least some antipodal pairs characterized in that the optical power at one point of the pair is higher than the optical power at the other point of the pair by at least one third or at least one half of the optical power.

In some embodiments of the present invention the optical power map of the lens is asymmetric both in the near-viewing zone and in the far-viewing zone. This is contrary to conventional lenses which are generally symmetric at the far-viewing zone. Preferably, for any base curve value and optical add power, the asymmetry matrix has one or more far-viewing zone entries (e.g., entries corresponding to a location 15 mm or more above the 0-180 line of the lens) which are above one fifth of the optical add power of the lens. Preferably, 70% or more of the far-viewing zone entries in the asymmetry matrix are above 0.02 diopters.

The asymmetry of the lens device of the present embodiments can also be expressed in terms of the variations of the optical power P along the horizontal coordinate x or along the vertical coordinate y. Each of the functions P(x) and P(y), which describe the variations of the optical power along the horizontal and vertical coordinate, respectively, has different properties at the temporal part than at the nasal part.

In some embodiments of the present invention P(x) is substantially monotonic at the temporal part of the lens. At the nasal part, particularly below the 0-180 line of the lens, P(x) exhibits local minima. In various exemplary embodiments of the invention the local minima of the P(x) are also global minima. In some embodiments, P(x) for y=−5 mm has a minimum at x=15 mm, in some embodiments, P(x) for y=−10 mm has a minimum at x=20 mm, and in some embodiments P(x) for y=−15 mm has a minimum at x=25 mm. Other local minima, particularly below the 0-180 line of the lens, are not excluded from the scope of the present invention.

In some embodiments of the present invention P(y) is substantially monotonic at the temporal part of the lens. At the nasal part, particularly at a distance of 15 mm or more from the main meridian of the lens, P(y) exhibits local maxima and optionally also local minima. In various exemplary embodiments of the invention P(y) has a local maximum at y=0 for any x≧15 mm. In some embodiments of the present invention P(y) for x=15 mm has a local minimum at y=−10 mm. Other local minima, particularly in the vicinity of x=15 mm are not excluded from the scope of the present invention.

In some embodiments of the present invention the cylinder value map of the lens is asymmetric with respect to the main meridian. At the far-viewing zone, e.g., at a distance of at least 8 mm above the 0-180 line of the lens, the cylinder value is practically zero (preferably less than 1 diopters for optical add power of 2.5 diopters or less, and less than 1.2 diopters for higher optical add powers) at any location in the nasal part up to a distance of 30 mm from the geometrical center of the lens, and non-zero (e.g., at least 50% of the optical add power) at least at several locations in the temporal part.

Some embodiments of the present invention are concerned with a method suitable for designing a progressive addition surface. The method calculates optical powers over the surface so as to provide a near-viewing zone, a far-viewing zone and a transition corridor.

The optical powers are calculated using a two variable function which has a dependence on the horizontal and vertical coordinates x and y. Preferably, the function possesses substantial asymmetry along the horizontal direction. In some embodiments, the dependence on x at the temporal part is generally the same (e.g., within 20% more preferably within 10%) for any y over the surface. The dependences of the function on x at the nasal part of the surface can be different for different vertical locations. The asymmetry of the function can also be expressed in terms of slopes with respect to the vertical location. In some embodiments of the present invention the slope is steeper at the nasal part than at the temporal part. Once the optical powers are calculated, the method employs surface optimization procedure so as to reduce astigmatism error over the temporal part and nasal part separately.

The optimization is preferably performed locally by virtually dividing the surface of the lens to domains and processing them one at a time. Some domains can be excluded from the optimization procedure. Preferably domains corresponding to the near-viewing zone and far-viewing zone are excluded. Optionally, domains corresponding to the transition corridor are also excluded. The optimization procedure features an objective function which is optimized (e.g., minimized) over the processed domain. The objective function can be the sum or average of the cylinder values over the respective domain. The processing optionally and preferably includes the use of one or more weight functions. For example, the weight functions can be used for calculating the objective function as a weighted sum or a weighted average of the cylinder values over the domain. In various exemplary embodiments of the invention the optimization includes dynamic adaptation of the weight functions.

According to an aspect of some embodiments of the present invention there is provided a progressive addition lens device. The device comprises: a lens body formed with a progressive power surface having a temporal part and a nasal part, and being characterized by an optical power map having a plurality of contours corresponding to transitions between optical powers across the surface, wherein at least 70% of the contours are substantially monotonic at the temporal part.

According to some embodiments of the invention all contours above a horizontal line passing 15 mm below a central horizontal line of the map are substantially monotonic at the temporal part.

According to some embodiments of the present invention at least some contours are non-monotonic at the nasal part.

According to some embodiments of the present invention at least some contours above a horizontal line passing 15 mm below a central horizontal line of the map are non-monotonic at the nasal part.

According to some embodiments of the present invention at least one contour is substantially monotonic across the entire progressive power surface, but has an inflection point at a meridian between the nasal part and the temporal part.

According to some embodiments of the present invention all contours within an angular span of at least 100 degrees within the temporal part are substantially monotonic.

According to some embodiments of the present invention an angular span for which all the contours are substantially monotonic at the nasal part is of less than 40 degrees.

According to some embodiments of the present invention the optical power map is asymmetric in a near-viewing zone of the map and in a far-viewing zone of the map.

According to some embodiments of the present invention the optical power map is characterized by an asymmetry matrix having at least one entry which is above one third of an optical add power of the lens device.

According to some embodiments of the invention the asymmetry matrix has at least one far-viewing zone entry which is are above one fifth of the optical add power.

According to some embodiments of the present invention a variation of the optical power as a function of a horizontal coordinate x is substantially monotonic at the temporal part, but exhibits at least one local minimum at the nasal part.

According to some embodiments of the present invention the at least one local minimum is also a global minimum.

According to some embodiments of the present invention the local minimum or minima is/are located below a central horizontal line of the lens.

According to some embodiments of the present invention a variation of the optical power as a function of a vertical coordinate y is substantially monotonic at the temporal part, but exhibits at least one local maximum at the nasal part.

According to some embodiments of the present invention the device is characterized by a cylinder value map which is asymmetric with respect to a main meridian of the cylinder value map.

According to some embodiments of the present invention at least several far viewing locations over the the temporal part are characterized by a cylinder value which is at least 50% of an optical add power of the device.

According to an aspect of some embodiments of the present invention there is provided a progressive addition lens device. The device comprises: a lens body formed with a progressive power surface having a temporal part and a nasal part situated at both sides of a main meridian. The progressive power surface is characterized by an optical power map which is asymmetric with respect to the main meridian both in a near-viewing zone and in a far-viewing zone of the lens body. According to some embodiments of the present invention the optical power map is asymmetric with respect to an eyepath of the device.

According to an aspect of some embodiments of the present invention there is provided a progressive addition lens device. The device comprises: a lens body formed with a progressive power surface having a temporal part and a nasal part situated at both sides of a main meridian, wherein a variation of the optical power as a function of a horizontal coordinate x perpendicular to the main meridian is substantially monotonic at the temporal part, but exhibits at least one local minimum at the nasal part.

According to some embodiments of the present invention a surface of the lens body, opposite to the progressive power surface, is finished.

According to some embodiments of the present invention a surface of the lens body, opposite to the progressive power surface, is unfinished.

According to an aspect of some embodiments of the present invention there is provided a method of forming a lens, comprising surfacing the unfinished surface according to at least one of: a prescribed far-vision optical power, a prescribed cylinder power and a prescribed axis.

According to some embodiments of the invention the present invention there is provided a mold device for forming a progressive addition lens device, comprising a mold body shaped complementarily to the lens body as described above and/or exemplified hereinbelow.

According to an aspect of some embodiments of the present invention there is provided a method of forming a progressive addition lens device. The method comprises introducing a lens material to the mold device and casting the progressive addition lens device using the mold.

According to an aspect of some embodiments of the present invention there is provided a method of forming a progressive addition lens device, comprising feeding into a free forming fabrication apparatus properties of at least one of the progressive power surfaces described above and/or exemplified hereinunder.

According to an aspect of some embodiments of the present invention there is provided a spectacles device comprising the lens device described above and/or exemplified hereinunder.

According to an aspect of some embodiments of the present invention there is provided a method of improving vision. The method comprises wearing the spectacles device.

According to an aspect of some embodiments of the present invention there is provided a method of optimizing a progressive power surface characterized by an initial optical power map. The method comprises: virtually dividing said surface to domains; and for at least one of the domains, processing cylinder values over the domain so as to optimize an objective function defined over the domain, thereby optimizing the progressive power surface.

According to some embodiments of the invention the objective function comprises a sum of cylinder values over the domain.

According to some embodiments of the invention the sum is a weighted sum featuring a weight function.

According to some embodiments of the invention the method comprises updating the weight function and repeating at least one of the dividing and the processing using the updated weight function.

According to some embodiments of the invention the method comprises masking at least some regions over the progressive power surface so as to exclude the masked regions from the processing.

According to some embodiments of the invention the masked regions comprise at least one of a near-viewing zone, a far-viewing zone and a corridor of the surface.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system.

In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a progressive addition lens (PAL) device, according to some embodiments of the present invention;

FIG. 2A is a schematic illustration of a side view of the PAL device, according to some exemplary embodiments of the present invention;

FIG. 2B is a schematic illustration showing various optical features of the lens, according to some embodiments of the present invention.

FIG. 3 is an optical power map of a PAL device, according to various exemplary embodiments of the present invention;

FIGS. 4A-F are graphs showing the optical power as a function of the polar coordinate for several PALs, in accordance with some exemplary embodiments of the present invention;

FIG. 4G shows the polar coordinate system used for drawing the graphs of FIGS. 4E-F;

FIG. 5 is a graph showing the optical power of for a progressive surface as a function of a polar coordinate for the nasal part of the surface, according to an exemplary embodiment of the present invention;

FIG. 6 is a graph which shows the optical power as a function of the horizontal location across a progressive surface, according to an exemplary embodiment of the present invention;

FIG. 7 is a cylinder value map, according to an exemplary embodiment of the present invention, for a base curve of 4 diopters and optical add power of 2 diopters;

FIG. 8 is a flowchart diagram of a method suitable for designing a progressive power surface, according to various exemplary embodiments of the present invention;

FIG. 9 is a graph showing the dependence of a function for calculating optical powers on the horizontal direction, according to various exemplary embodiments of the present invention;

FIG. 10 shows optical power in arbitrary units as a function of vertical; coordinates, as calculated according to various exemplary embodiments of the present invention along the main meridian, and 2 mm offset the main meridian into the temporal and nasal parts;

FIG. 11 is a schematic flowchart of an optimization procedure according to some embodiments of the present invention;

FIGS. 12A-D show typical shapes of weight functions, which can be used for designing a PAL device according to some embodiments of the present invention;

FIGS. 13A and 13B show optical power as a function of a horizontal coordinate for a conventional PAL and a PAL designed according to some embodiments of the present invention;

FIG. 14 shows difference in optical power between a conventional PAL and a PAL designed according to some embodiments of the present invention;

FIG. 15 is a schematic illustration of a virtual division of a lens into 12 domains according to an exemplary embodiment of the present invention; and

FIG. 16 is a three-dimensional representation of a power slope for a base curve of 4.50 D and optical add power of 2.00 D, according to some exemplary embodiments of the present invention.

### DESCRIPTION OF SPECIFIC EMBODIMENTS OF THE INVENTION

The present invention, in some embodiments thereof, relates to optics and, more particularly, but not exclusively, to a progressive addition lens and methods for designing and/or manufacturing a progressive addition lens.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

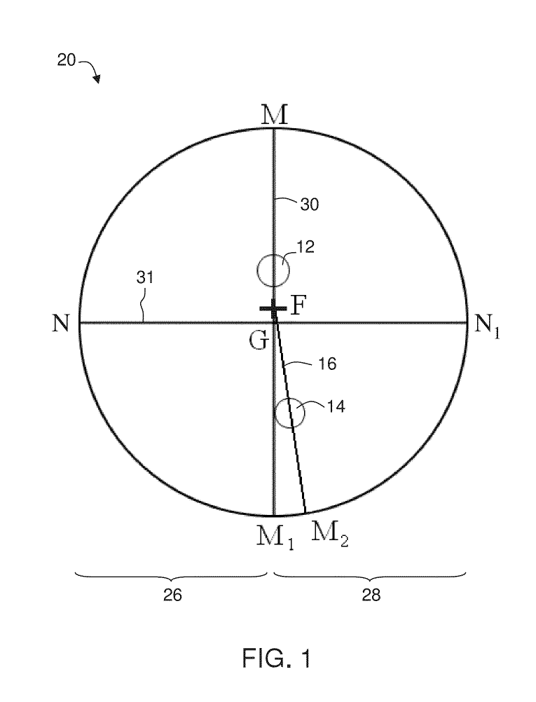

For purposes of better understanding some embodiments of the present invention, reference is first made to FIG. 1 which will be used to explain the nomenclature used herein. FIG. 1 illustrates a progressive addition lens (PAL) 20, according to some embodiments of the present invention. Lens 20 is illustratively represented by a circle, centered at G. One straight line 30 connects two points M and M₁ on the periphery of the circle, and another straight line 31 connects two other points N and N₁ on the periphery of the circle. Lines 30 and 31 are perpendicular to each other and intersect at G. Line 30 is drawn vertically in FIG. 1 and represents a lens feature known as “the main meridian” of the lens. Line 31 is drawn horizontally in FIG. 1 and represents a lens feature known as “central horizontal line.” G represents the geometrical center of the lens.

The direction parallel to the main meridian 30 is referred to herein as the vertical direction, and the direction perpendicular to the main meridian 30 and parallel to the central horizontal line 31 is referred to herein as the horizontal direction. Some embodiments of the invention are described with reference to a Cartesian system of coordinates (x, y) where x is measured along the horizontal direction (and referred to as the horizontal coordinate) and y is measured along the vertical direction (and referred to as the vertical coordinate). The origin (x=0, y=0) is selected at the geometrical center of the lens. Thus, for example, in the present Cartesian coordinate system, the main meridian is at x=0 and central horizontal line is at y=0.

The main meridian 30 divides lens 20 into two parts, referred to as the temporal part and the nasal part of lens 20. For a PAL intended to be positioned in front of the left eye of the wearer, the nasal and temporal parts, as viewed by the left eye, are at the right side and left side of main meridian 30, respectively. Conversely, for a PAL intended to be positioned in front of the right eye of the wearer, the nasal and temporal parts, as viewed by the right eye, are at the left side and right side of main meridian 30, respectively. The temporal part and nasal part are designated in FIG. 1 by reference numerals 26 and 28, respectively.

It is convenient to describe the various regions of the surface of the lens in terms of a polar coordinate φ, where φ=0° corresponds to the part of the line 31 at the temporal side of the lens, φ=180° corresponds to the part of line 31 at the nasal side of the lens, φ=90° corresponds to the part of the main meridian 30 which is above line 31, and φ=270° (or equivalently)-90° corresponds to the part of the main meridian 30 which is below line 31. Line 31 is interchangeably referred to herein as the 0-180 line. When the wearer is in an upright position, the main meridian is approximately vertical and the 0-180 line is approximately horizontal, hence the use of terms “vertical,” “horizontal,” “above” and “below.” All these definitions are known to those skilled in the art of lens design.

Lines 30 and 31 are typically imaginary, namely they are not materialized on the surface of the lens. Also shown in FIG. 1 is a cross F which represents a lens feature known as “the fitting cross” of the lens. Typically, the fitting cross F is materialized on the lens surface and is used by the optician for mounting the lens in the frame. The fitting cross is useful for positioning the lens in front of the wearer's eye. For example, the fitting cross can be located on the main meridian about 2 mm above the geometrical center of the lens.

Typically, a PAL also has two additional marks that are materialized on the lens surface. These marks, shown in FIG. 1 as circles 12 and 14, are known as “the distance checking circle” and “near checking circle.” The center of the distance checking circle 12 is typically on the main meridian 30, e.g., about 8 mm above the geometrical center G. The center of the near checking circle 14 is typically marked below line 31, e.g., about 14 mm below the line 31. The center of the near checking circle 14 is off the main meridian 30, typically at the nasal part 28 of the lens. In other words, the straight line 16 passing through the fitting cross F and the center of the near checking circle 14 is at a small angle, typically from about 7° to about 11°, e.g., about 8°, to the main meridian. Line 16 intersects the periphery of the circle at M₂. The (broken) line connecting the three points M, F and M₂ is referred to as “the eyepath” of the lens, since it represents the convergence of the eyes when focusing on nearby objects.

In conventional PALs, the optical power map of the PAL is symmetric with respect to the eyepath of the PAL. The optical power maps are symmetric in the sense that the map at right hand side of the eyepath is substantially a mirror image of the map at left hand side of the eyepath.

While conceiving the present invention it has been hypothesized and while reducing the present invention to practice it has been realized that a PAL having an asymmetric optical power map can provide a significant improvement in viewing comfort to the wearer. The PAL device of some embodiments of the present invention is characterized by asymmetric optical power map. The asymmetry can be expressed both with respect to the main meridian and with respect to the eyepath, as further detailed hereinbelow.

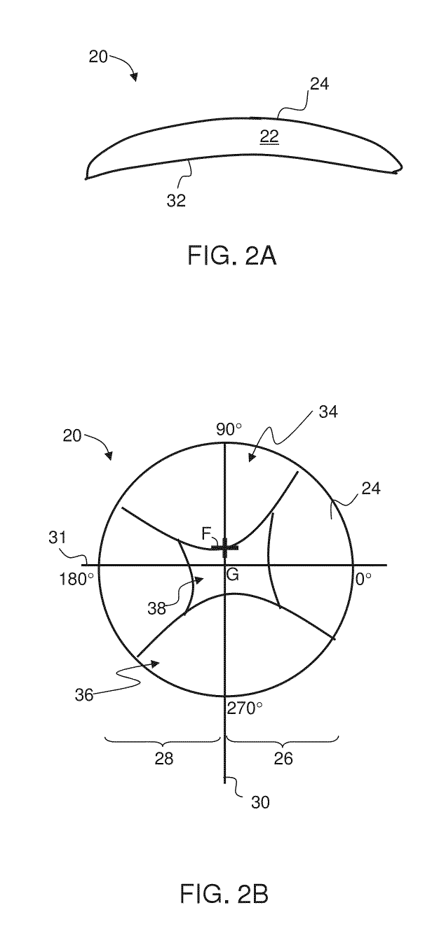

Turning now to a more detailed description of the invention, FIG. 2A is a side view (FIG. 2A), and FIG. 2B is a front view of lens 20, showing the various optical features of the lens, according to some embodiments of the present invention. Lens 20 comprises a lens body 22 formed with a progressive power surface 24.

As used herein, “progressive power surface” refers to a continuous aspheric surface having far- and near-viewing zones, and a transition corridor of varying optical power transitioning between the far- and near-viewing zones. The curvature defining the far-viewing zone is referred to as the “base curve” of the progressive power surface, and the amount of optical power difference between the far-viewing zone and the near-viewing zone is referred to as the “optical add power” of the progressive power surface. According to the common conventions, the optical add power of a progressive power surface has a positive value, which is typically expressed in diopters.

When the progressive surface is the convex surface of lens body 22 (as exemplified in FIG. 2A), the curvature at the far-viewing zone is less than that at the near-viewing zone. However, this need not necessarily be the case, since the progressive surface can also be the concave surface 32 of lens body 22, in which case the curvature at the far-viewing zone is greater than that at the near-viewing zone. Also contemplated are embodiments in which device 20 includes two progressive surfaces, one on the convex surface and one on the concave surface of lens body 22. Further contemplated are embodiments in which one surface of the lens is shaped according to the base curve and the opposite surface is shaped to impart the progressive addition properties.

Lens 20 also, conventionally, has a fitting cross F, as further detailed hereinabove. In some embodiments of the present invention fitting cross F is located about 2 mm above the geometrical center G of lens 20. Geometrical center G is, in some embodiments, at the optical center of the lens.

The far-viewing zone, near-viewing zone and transition corridor are generally shown in FIG. 2B at 34, 36 and 38, respectively. Also shown is meridian line 30 separating between temporal part 26 and nasal part 28, and passing through the fitting cross F and the geometrical center G, as further detailed hereinabove. As shown, each of zones 34, 36 and 38 spans over a portion of temporal part 26 and a portion of nasal part 28. FIG. 2B also shows central horizontal line 31, which intersect meridian 30 perpendicularly thereto at the geometrical center G, as further detailed hereinabove. As shown, zones 34 and 36 are above and below line 31, respectively.

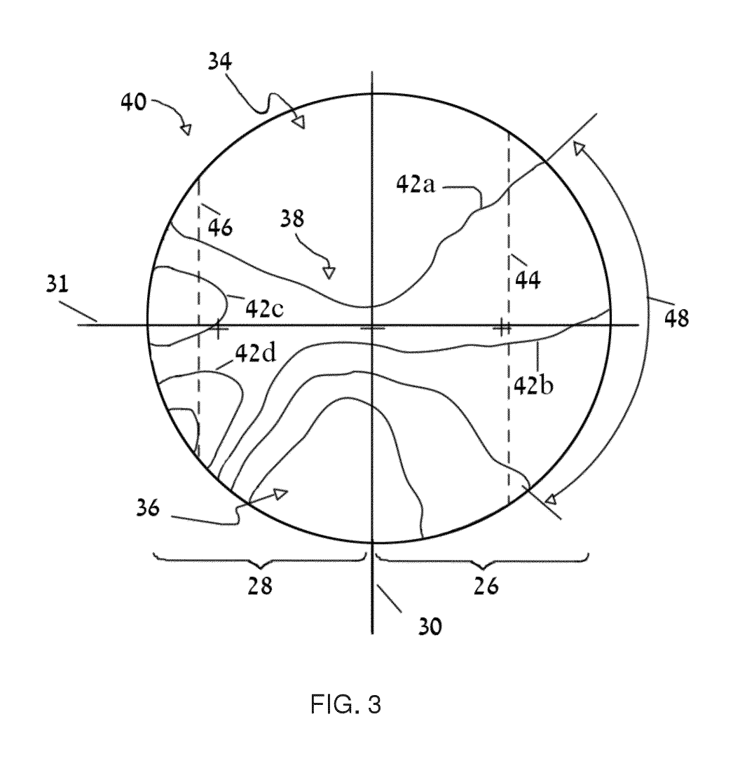

Surface 24 is characterized by an optical power map. A representative example of an optical power map 40, for a PAL according to an embodiment of the invention is depicted in FIG. 3. For clarity of presentation, the areas over map 40 which correspond to far-viewing zone 34, near-viewing zone 36 and transition corridor 38 are not also shown in FIG. 3.

Optical power map 40 has a plurality of contours, each corresponding to a line of constant optical power across surface 24, where points between the contours have intermediate values of optical power. Four of the contours of map 40 are designated by reference signs 42a, 42b, 42c and 42d, but map 40 can include any number of contours. Collectively, the contours of map 40 are referred to hereinunder as contours 42. In various exemplary embodiments of the invention at least 70% of the effective area in the temporal part is occupied by substantially monotonic contours.

“Effective area” as used herein is the total area through which light enters and is redirected to the eye of the wearer when the lens is at a state of wear. It is appreciated that the effective area can be smaller than the total area of surface 24 either because a peripheral portion can be cut-off, e.g., to fit a spectacles frame, or because light entering the peripheral part of surface 24 does not reach the pupil of the wearer. In some embodiments, the effective area spans to a distance of about at least 15mm or at least 16 mm or at least 17 mm or at least 18 mm or at least 19 mm or at least 20 mm or more from the optical center of the lens.

In various exemplary embodiments of the invention all the contours above a horizontal line being Y mm below the 0-180 line are substantially monotonic, where Y equals 10 or 11 or 12 or 13 or 14.

As used herein, a contour is said to be “monotonic” if it extends away from main meridian 30 to the edge of the lens body in a manner that it passes at most once through any distance from the main meridian. In other words, a monotonic contour intersects any imaginary line in the vertical direction at most once. Thus, a monotonic contour can be represented mathematically by a monotonic function of coordinates along the horizontal direction.

As used herein, a “substantially monotonic contour” refers to a contour which extends monotonically away from the main meridian to the edge of the lens body along at least 90% or at least 95% of its length.

In FIG. 3 contours 42a and 42b, for example, are substantially monotonic since they extend within temporal part 26 away from main meridian 30 and intersect any imaginary vertical line in temporal part 26 (e.g., line 44) at most once. In various exemplary embodiments of the invention at least a few of the contours are non-monotonic in the nasal part.

As used herein, a contour is said to be “non-monotonic” if it passes at least twice through at least one distance from the main meridian. In other words, a non-monotonic contour intersects any imaginary line in the vertical direction at least twice.

For example, contours 42c and 42d are non-monotonic since they have two intersections with one or more imaginary vertical lines (see line 46).

In various exemplary embodiments of the invention there is at least one or at least two non-monotonic between a first horizontal line being Y1 mm below the 0-180 line and a second horizontal line being Y2 mm above the 0-180 line, where Y1 and Y2 each independently equals 8 or 9 or 10.

Thus, map 40 possesses an asymmetry with respect to meridian 30 since it has monotonic contours at temporal part 26 and non-monotonic contours at nasal side 28. Map 40 also possesses an asymmetry with respect to the eypath (not shown see FIG. 1), since it has monotonic contours at the temporal side of the eyepath and non-monotonic contours at nasal side of the eypath.

Quantitatively, the asymmetry of map 40 can be expressed as a matrix referred to hereinunder as an “asymmetry matrix” M(x, y). Each entry of the asymmetry matrix represents a difference in optical powers for an antipodal pair of points.

As used herein “antipodal pair of points” means two points which reside symmetrically at both sides of the main meridian such that the location of each point is a minor image of the location of the other point about the meridian line.

Thus, for example, consider a pair of points p₁ and p₂, located along a horizontal line, 15 mm above the 0-180 line, where the p₁ is located 10 mm from the main meridian at the temporal side, and p₂ is located 10 mm from the main meridian at the nasal side. Such a pair is an antipodal pair since it resides symmetrically with respect to the main meridian. Suppose further that the optical power at p₁ is 4.5 and that the optical power at p₂ is 4.3. In this case the asymmetry matrix includes an entry M(10, 15)=4.5−4.3=0.2 diopters, corresponding to horizontal location of 10 mm and a vertical location of 15 mm. Representative examples of asymmetry matrices, according to some embodiments of the present invention are provided in the Examples section that follows.

The value of each matrix entry depends on the base curve value and optical add power of the lens. Preferably, however, for any base curve value and optical add power there are at least some entries which are more than X diopters, where X is 0.4 or 0.42 or 0.44 or 0.46 or 0.48 or 0.5. Namely, map 40 preferably has at least some antipodal pairs characterized in that the optical power at one point of the pair is higher than the optical power at the other point of the pair by at least X diopters.

In some embodiments of the present invention the optical power map of the lens is asymmetric also at the far-viewing zone. This is contrary to conventional lenses which are generally symmetric at this zone. Preferably, 70% or more of the entries in the asymmetry matrix which correspond to the far-viewing zone (e.g., 15 mm or more above the 0-180 line) are preferably above 0.02 diopters.

In various exemplary embodiments of the invention there is a relatively wide angular span at temporal part 26 in which the optical power is monotonic, and a relatively wide angular span at nasal part 28 in which the optical power is non-monotonic. The angular span is conveniently expressed in term of the polar coordinate φ, defined above. Thus, the angular span in which the optical power is monotonic is from about 0°−Δφ to about 0°+Δφ and the angular span in which the optical power is non-monotonic is from about 180°−Δφ to about 180°−Δφ, where Δφ is preferably at least 60° or at least 65° or at least 70°.

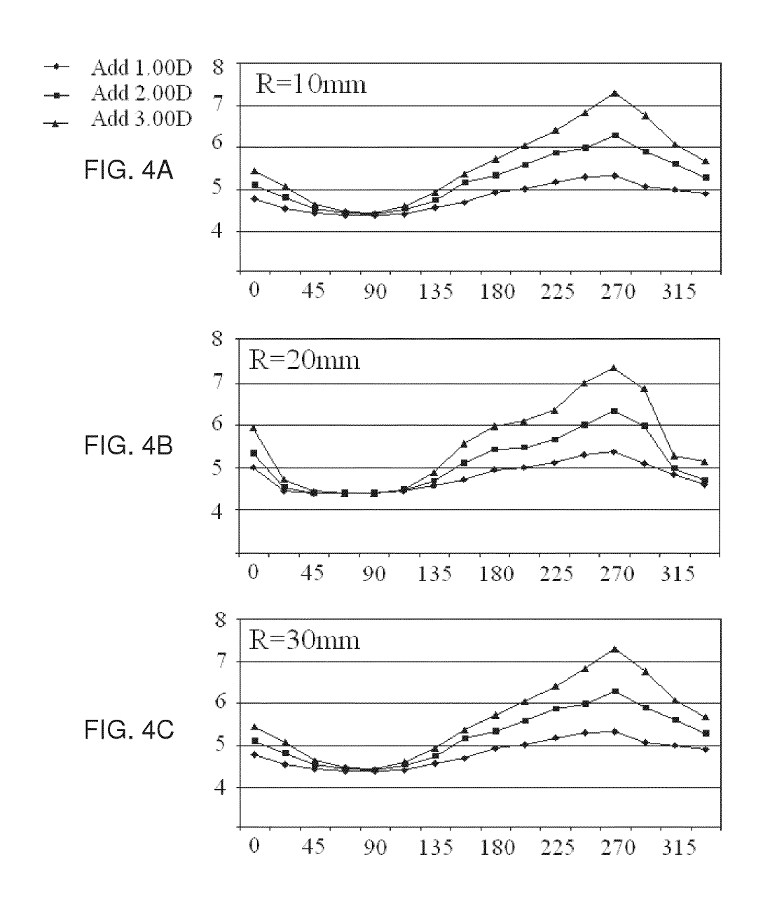

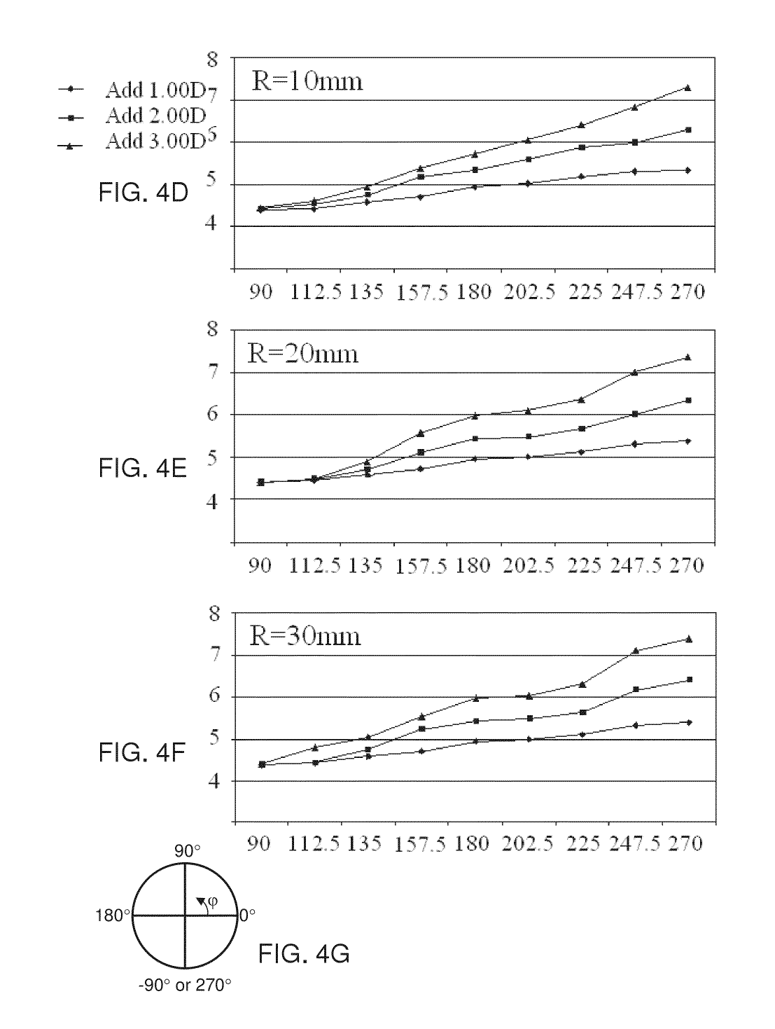

FIGS. 4A-F are graphs showing the optical power as a function of the polar coordinate φ for several PALs in accordance with various exemplary embodiments of the present invention. FIGS. 4A-C are drawn for the full polar range (0°≦φ≦360°), and FIGS. 4D-F are drawn only for a partial polar range (90°≦φ≦270°) for clearer presentation. The nasal part spans from φ=−90° (or equivalently 270°) at the near-viewing zone through φ=0° to φ=+90° at the far-viewing zone. The temporal part spans from φ=−90° at the near-viewing zone through φ=180° to φ=+90° at the far-viewing zone. The polar coordinate system used for drawing the graphs is shown in FIG. 4G.

Each of FIGS. 4A-F shows optical powers curves for optical add powers of 1, 2, and 3 diopters. FIGS. 4A and 4D show the curves as calculated at a distance of 10 mm from the geometrical center, FIGS. 4B and 4E show the curves as calculated at a distance of 20 mm from the geometrical center, and FIGS. 4C and 4F show the curves as calculated at a distance of 30 mm from the geometrical center. As shown, for all add powers, the optical power in the temporal part is monotonic with respect to φ over the range 90°<φ<270°. The data used for preparing FIGS. 4A-F are provided in the Examples section that follows (see Tables 32-37).

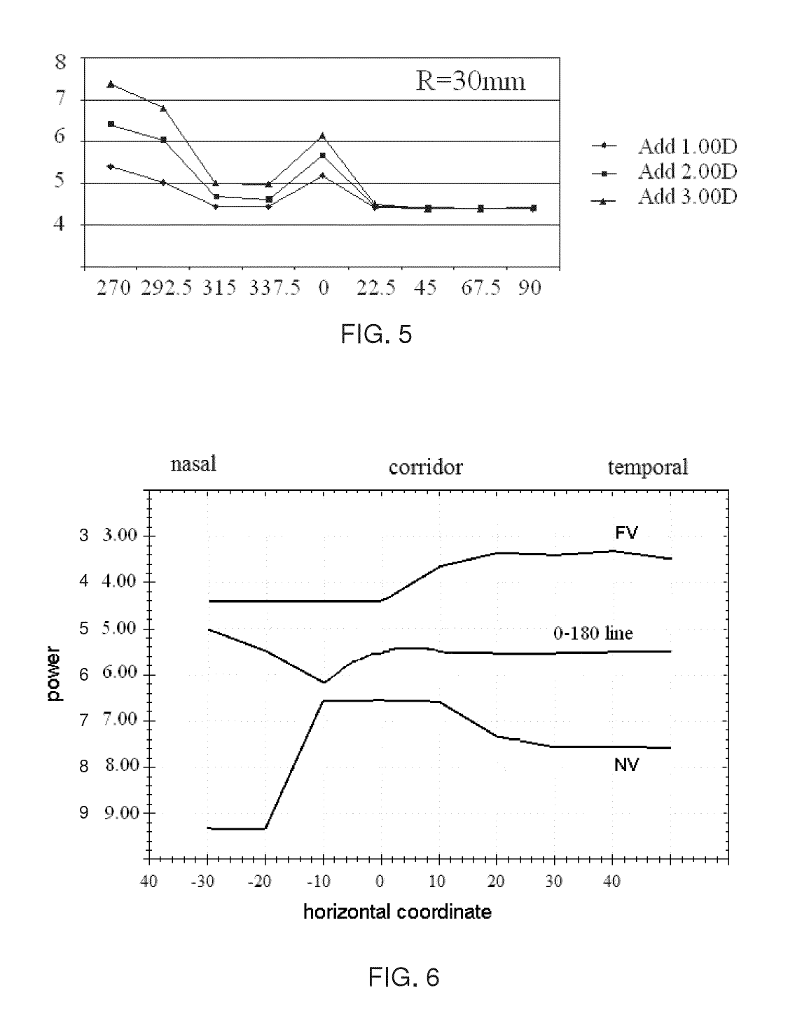

At the nasal part, the optical power is optionally non-monotonic, namely it has one or more local extrema. In essence, the present embodiments are based on a realization that a proper trade-off for a PAL allows for a decrease in optical quality in the nasal region to improve optical quality in the temporal region, as further detailed hereinbelow. FIG. 5 is a graph showing the optical power of add power of 1, 2 and 3 diopters as a function of the polar coordinate φ, for a distance of 30 mm from the geometrical center of the lens, according to some exemplary embodiments of the present invention. The polar coordinate system of FIG. 5 is the same as that of FIG. 4G. As shown in FIG. 5, the optical power in the nasal part is non-monotonic with respect to φ over the range 270°<φ<90°: there is one local maximum and one local minimum over this range. The data used for preparing FIG. 5 are provided in the Examples section that follows (see Table 38).

Reference is now made to FIG. 6 which shows the optical power as a function of the horizontal location across surface 24, according to an embodiment of the present invention. Shown in FIG. 6 are three representative curves: the middle curve corresponds to the 0-180 line; the bottommost curve correspond to a horizontal line passing at the near-viewing (NV) zone, 14 mm below the 0-180 line; and the topmost curve correspond to a horizontal line passing at the lower part of the far-viewing (FV) zone, 8 mm above the 0-180 line. With respect to the horizontal direction, the optical power, in the present embodiment of the invention, is non-monotonic at the near-viewing zone, and substantially monotonic (within deviations of less than 0.5 diopters or less than 0.4 diopters or less than 0.3 diopters from monotonicity) at the far-viewing zone. In various exemplary embodiments of the invention the optical power is also non monotonic along the 0-180 line. Preferably, along the 0-180 line, the optical power has a single extremum point at the nasal part and is generally constant (e.g., within 10%) at the temporal part. The value of the optical power along the 0-180 line at the temporal part can be approximately half the optical add power of device 20.

The human visual system possesses a physiological mechanism capable of inferring a complete image even when only one of the eyes actually receives the entire image information, provided that the overall information reaching the retinas is sufficient. Thus, in a complementary manner, the human visual system collects image information reaching each individual retina and combines the information such that the observer perceives a complete or nearly complete image.

It was found by the present inventors that PAL device 20 can be constituted taking into account the above physiological mechanism. Specifically, the present inventors envisioned that nasal part can have a higher level of astigmatism than the temporal part without substantially compromising the quality of vision. This is because for each eye the field-of-view at the nasal side is smaller than that at the temporal side, and because scene portions present within the field-of-view at the nasal side are typically perceived by both eyes. Thus, from the standpoint of a monocular vision, higher level of astigmatism at the nasal side is less uncomfortable since it only affects a small portion of the field-of-view, and from the standpoint of a binocular vision, image information lost or distorted from the field-of-view of one eye at the nasal side may arrive at the other eye, such that a complete or nearly complete image of the scene is inferred.

In some embodiments of the present invention progressive power surface 24 is of a mixed soft-hard design. Preferably, surface 24 is of a soft design at the temporal side and hard design at the nasal part.

The term “soft design” is known to those skilled in the art of optics and refers to a surface design in which the unwanted surface astigmatism is spread widely across the surface. The term “hard design” is also known to those skilled in the art of optics and refers to a surface design in which the unwanted surface astigmatism is compressed rapidly over a relatively small area of the surface.

In various exemplary embodiments of the invention “unwanted surface astigmatism” refers to surface astigmatism of at least 0.5 diopters. The term “unwanted surface astigmatism” is abbreviated herein as “surface astigmatism.”

Thus, in the present embodiments, the area over which the surface astigmatism is spread is larger at the temporal side than at the nasal part. In some embodiments of the present invention, the surface astigmatism at the nasal part does not extend into the far-viewing zone by more than 8 mm above the 0-180 line. In some embodiments of the present invention, the surface astigmatism at the temporal part extends into the far-viewing zone at least 15 mm above the 0-180 line. In the vicinity of the 0-180 line (e.g., for |x|≧10 mm there are at least several antipodal pair of points for which the surface astigmatism is higher by more than 0.5 diopters at the point in the temporal part than at the point in the nasal part.

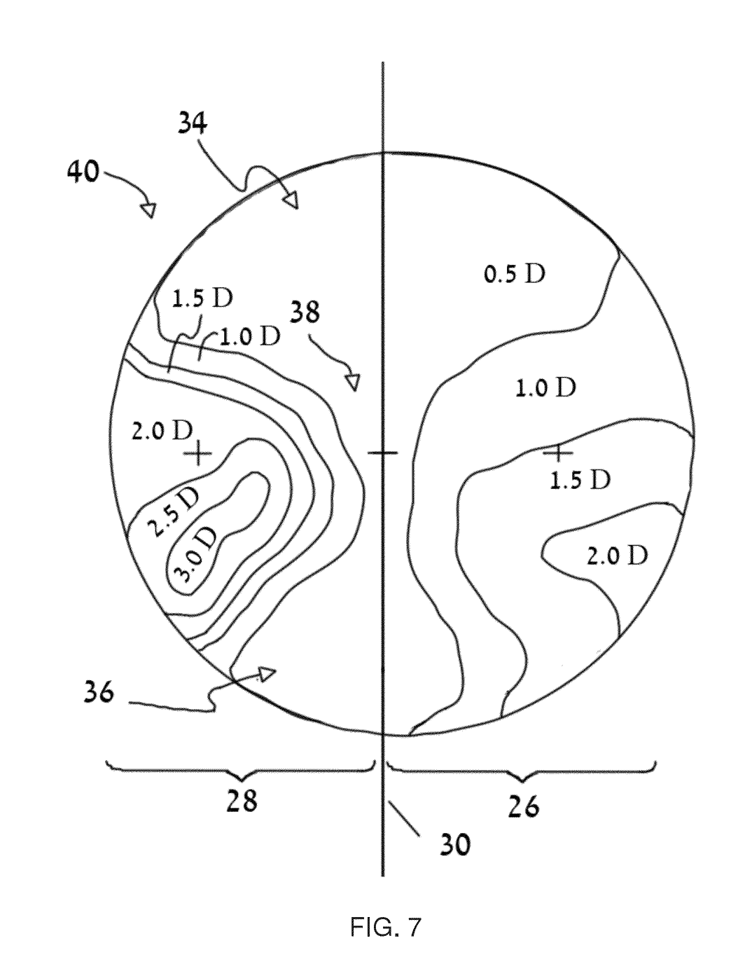

Therefore, the cylinder value map characterizing surface 24 is asymmetric with respect to meridian 30. A representative example of a cylinder value map 50 is depicted in FIG. 7, for a base curve of 4 diopters and optical add power of 2 diopters. The areas over map 50 which correspond to far-viewing zone 34, near-viewing zone 36 and transition corridor 38 are also shown in FIG. 7.

Preferably, nasal part 28 has one or more regions corresponding to cylinder values higher than any cylinder value which may exist in temporal part 26. In some embodiments, nasal part 28 includes one or more zones or part of zones which is characterized by a cylinder value which is the same as or higher than (e.g., by at least 10% or 20% or 30% or 40%) the optical add power of the lens.

In some embodiments of the present invention the maximal cylinder value at temporal part 26 equals the add power of surface 24.

The PAL device of the present embodiments can be provided as either a finished or semi-finished PAL device.

When the PAL device is a finished PAL device, both the progressive power surface and the opposite surface are finished. The progressive power surface is “finished” in the sense that it has a particular base curve and optical add power. The opposite surface can have surface properties which are governed by the cylinder and/or optical powers correction required to compensate refractive aberrations of a particular wearer or group of wearers. The combination of powers on both surfaces provides the required power which complies with the prescription of the wearer or group of wearers. In the embodiments in which the PAL device is finished, the center thickness of the lens body is dependent on the base curve and optical add power. A minimum center thickness can optionally be defined to provide the lens body with sufficient mechanical strength.

When the PAL device is a semi-finished PAL device, the progressive power surface is finished to a particular base curve and optical add power combination while the opposite surface is unfinished and may be spherical. These embodiments are particularly useful when the PAL device is sold to a manufacturing optician or optical lab. The lab can keep a stock of the semi-finished PAL devices of the present embodiments. Typically, the lab keeps a stock of various PAL design families, where each design family correspond to a particular material and refractive index of the lens body, and each PAL device within the design family corresponds to a different combination of base curve and optical add power. The range of far-vision optical powers for which a semi-finished PAL of a particular base curve and optical add power is suitable is determined by the material, index and design.

When preparing a PAL device for an individual's spectacles, the manufacturing optician or optical lab surfaces and polishes the unfinished surface of the semi-finished PAL to fit the individual's prescription. If the individual's prescription does not include astigmatism correction, then the unfinished surface is preferably surfaced and polished so that the prescribed far-vision optical power is provided by the finished progressive power spectacle lens. The surfacing may involve adjusting the spherical curvature of the unfinished surface. If the individual's prescription includes astigmatism correction, then the unfinished surface is surfaced and polished so that the prescribed far-vision optical power, the prescribed cylinder value and the prescribed axis are provided by the finished progressive power spectacle lens. The surfacing may involve adjusting the spherical curvature of the unfinished surface and adding a toric component to the unfinished surface of the lens. In these embodiments, the lens body preferably has a thickness in excess of that required for a finished PAL device. The excess material permits the manufacturing optician or optical lab to grind and polish the unfinished surface.

The PAL device of the present embodiments can be provided as an assembled lens of an optical assembly such as a spectacles device or the like. The user can then use the optical assembly, e.g., by wearing the assembly, for improving his vision. In these embodiments, the lens body of the PAL device is preferably cut to fit the frame of the optical assembly. Alternatively the PAL device of the present embodiments can be provided as a separate unit, in which case it can be either cut to fit a frame or provided uncut.

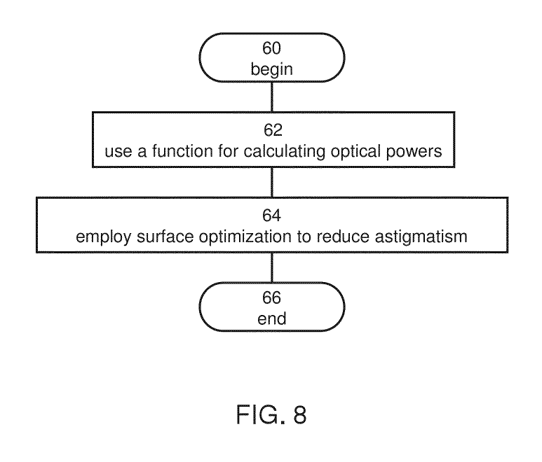

Reference is now made to FIG. 8 which is a flowchart diagram of a method suitable for designing a progressive power surface. The method is particularly useful for designing surface 24 of device 10.

The method begins at 60 and continues to 62 at which optical powers are calculated over the surface so as to provide a near-viewing zone, a far-viewing zone and a transition corridor. The input for calculating the optical powers is the desired base curve and add power of the lens. The optical powers are calculated using a two variable function which has a dependence on the horizontal and vertical directions, as defined above.

According to surface theory, when the optical power varies in the vertical direction along the main meridian, the astigmatism error away from the main meridian also varies, and the rate of charge in surface astigmatism is twice the rate of change of optical power. This relation is known as the Minkwitz theorem, and can be written as:

∂A(x, y)/∂x=2∝P(x, y)∂y, (EQ. 1)

where A is the astigmatism error (difference between orthogonal curvatures at a point), P is the optical power, and x and y are the coordinates along the horizontal and vertical directions, respectively.

In traditional techniques, the design begins by employing a set of procedures for handling the astigmatism error, and the distribution of optical power along the main meridian is selected so as to maintain the astigmatism error as low as possible. The present inventors found that a progressive power surface can be designed by considering optical powers before any handling of astigmatism errors.

At the temporal part of the surface, the dependence of the two-variable function of the present embodiments on the horizontal direction x can be generally the same (e.g., within 20% more preferably within 10%) for all vertical locations over the surface. At the nasal part of the surface, the dependence of the function on the horizontal direction x for one vertical location y₁ can be different than for another vertical location y₂. Thus, the function possesses asymmetry along the horizontal direction.

The dependence of the function on the horizontal direction x can be determined, for example, by plotting a graph of the function for several fixed values of the vertical coordinate y and as a function of the horizontal coordinate x.

A representative example of such graph is shown in FIG. 9. The shown graph is a schematic power shape of a surface with base curve of 4.50 diopters and optical add power of 2.00. The values are calculated in steps of 2 mm in the y direction from y=−14 to y=14 mm, and in steps of 1 mm in the x direction each from x=−42 mm to x=42 mm.

In FIG. 9 the optical center of the surface is conveniently chosen as (x, y)=(0,0), with negative and positive horizontal coordinates for the temporal and nasal parts, respectively, and positive and negative vertical coordinates for the far- and near-viewing zones, respectively. The graph consists of several lines (one for each values of y) along which the optical power reaches minimum. In various exemplary embodiments of the invention all lines at the temporal part can be superimposed one on the other by translation but without any rotations, such that the lines match one another within a maximal match error of 20% or 10%.

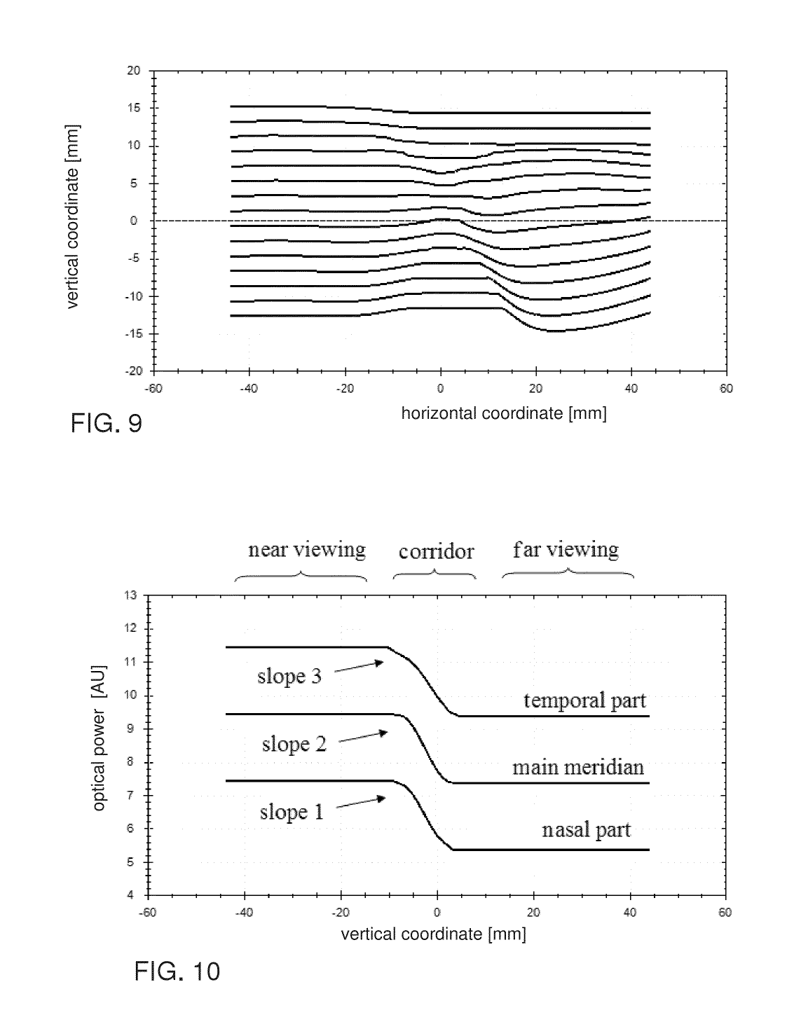

The asymmetry of the function is also illustrated in FIG. 10 which shows the optical power in arbitrary units as returned by the asymmetric function of the present embodiment for fixed horizontal coordinates but as a function of the vertical coordinate. FIG. 10 shows three curves, corresponding to the calculation along three vertical lines at horizontal coordinates x=−2 mm (namely 2 mm offset the main meridian into the temporal part), x=0 mm (namely the main meridian) and x=+2 mm (namely 2 mm offset the main meridian into the nasal part). At the far-viewing and near-viewing zones, all curves are substantially flat, since they correspond to fixed optical powers. At the transition corridor, all the curves are decreasing from the near-viewing zone to the far-viewing zone. Yet, the slope ∝P/∝y which characterizes the decrease along the vertical direction is not the same for all curves.

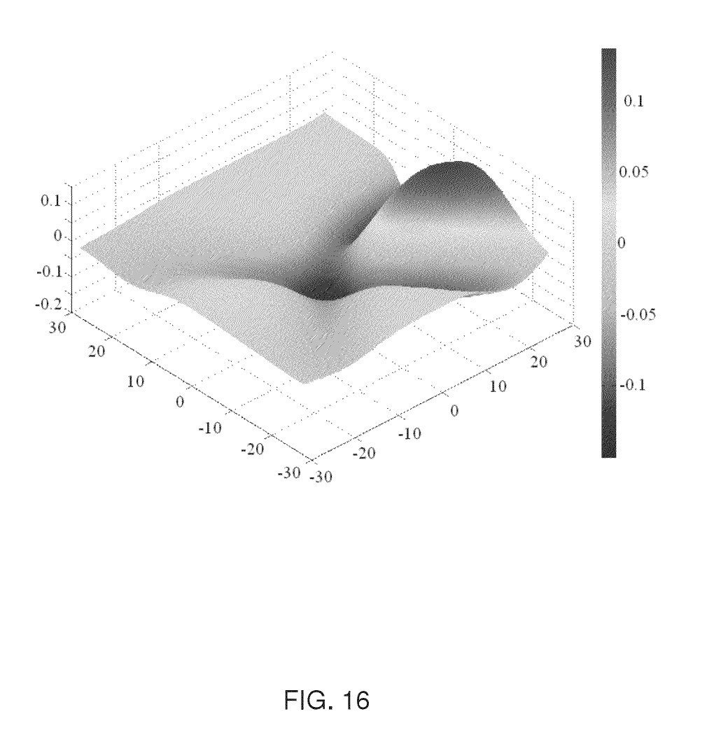

At the nasal part, the slope (designated “slope 1” in FIG. 10) is steeper (greater in absolute value) than the slope at the main meridian (designated “slope 2”). At the temporal part, on the other hand, the slope (designated “slope 3” in FIG. 10) is less steep than the slope at the main meridian. Representative examples of slopes suitable for some embodiments of the present invention are provided in the Examples section that follows (see Tables 39A-B and 40A-B and FIG. 16).

Thus, the function's slope is not symmetric with respect to the main meridian: it has a steeper dependence on the vertical coordinate at the nasal part than at the temporal part. Note that since the absolute value of the slope is greater at the nasal part than at the temporal part there is a higher astigmatism error for the nasal part than for the temporal part, since the absolute value of the slope is greater at the nasal part than at the temporal part. This is in accordance with the aforementioned envision of the present inventors that nasal part can have a higher level of astigmatism than the temporal part.

Once the optical powers are calculated, the method continues to 64 at which a surface optimization procedure is employed so as to reduce astigmatism error over the temporal part. Any surface optimization procedure can be employed. Representative examples include the optimization techniques disclosed in U.S. Pat. No. 6,183,084, 4,838,675, 6,382,789, 5,137,343, 6,089,713.

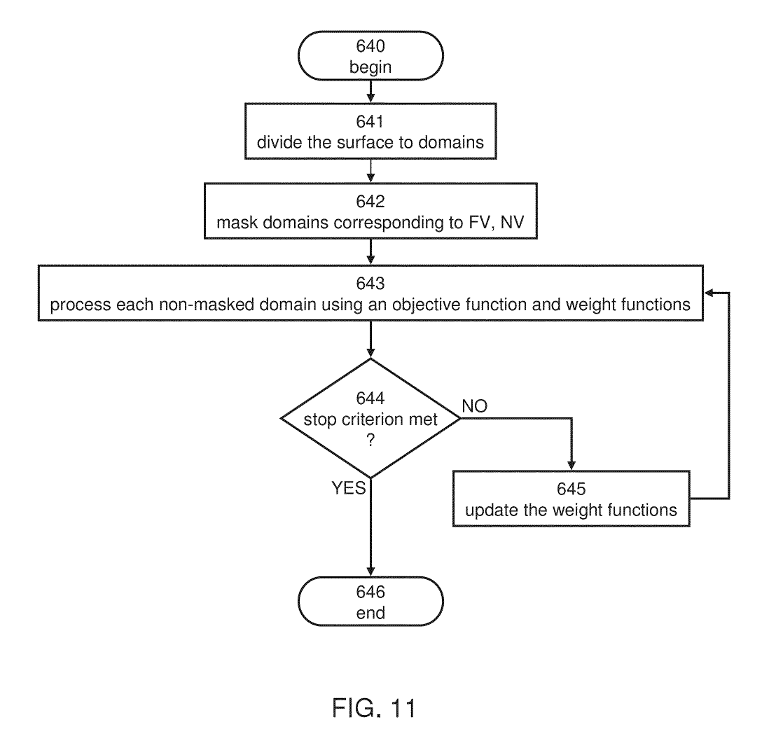

FIG. 11 is a flowchart diagram describing an optimization procedure suitable for being implemented at 64.

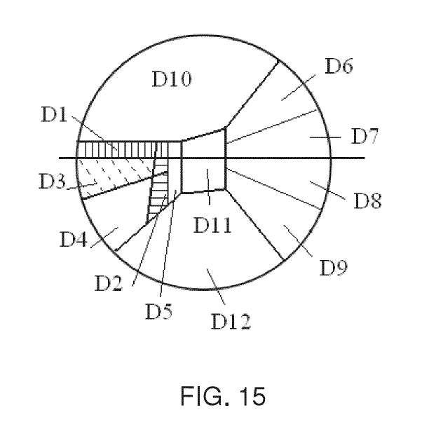

The procedure begins at 640 and continues to 641 at which the surface of the lens is virtually divided into a N domains Dᵢ, i=1, 2, . . . , N. Preferably, the domains are different in their shape and area. The initial number, shapes and areas of the domain, is preferably selected in accordance with the desired optical add power of the lens. In various exemplary embodiments of the invention the number N of domains, as well as their shapes and sizes are dynamically updated during the optimization procedure. A non-limiting example of a set of 12 domains is illustrated in FIG. 15. This set is suitable for a lens having a base curve of 4.50 diopters and an optical add power of 2.00 diopters. Other shapes, sizes and number of zones are not excluded from the scope of the present invention.

The method preferably continues to 642 at which domains corresponding to the near-viewing zone and far-viewing zone are masked. Optionally, the method also masks domains corresponding to the corridor. The purpose of the masking is to exclude the masked domains from being subjected to the optimization. The masking can be characterized by any geometrical figure that depends on the shape of the respective zone. The geometrical figure can be elliptic, rectangular or any shape.

The method continues to 643 at which each non-masked domain is processed using an objective function. Specifically, the objective function is optimized (e.g., minimized) over the domain being processed. Any type of objective function can be employed. Representative examples include, without limitation, the sum of the cylinder values and the mean value of cylinders of the domain. Thus, the procedure visits different points (x, y) with the domain, and optimizes the objective function by varying the local radius of curvature so as to reduce the cylinder value at the visited points. As a result, the optical power at the visited points also varies. The procedure preferably optimize the same type of objective function for all non-masked domains, but the use of different type of objective functions for different domains is not excluded from the scope of the present invention. Any scanning scenario can be used for visiting points in the domain being processed. Representative examples include, without limitation, raster scanning, random scanning and conditional scanning. In some embodiments, several points may be marked a priori for being excluded from the scan.

The processing optionally and preferably includes the use of one or more weight functions W(x, y), which return a point-specific weight for each visited point. For example, the objective function can be a weighted sum or a weighted average of the cylinder values over the domain, wherein W(x, y) is used as the weight for the cylinder value at point (x, y). The procedure can use the same type of weight function for all non-masked domains, or it can use different weight functions for different domains.

Many types of weight functions are contemplated. In some embodiments, the weight function W(x, y) has the form:

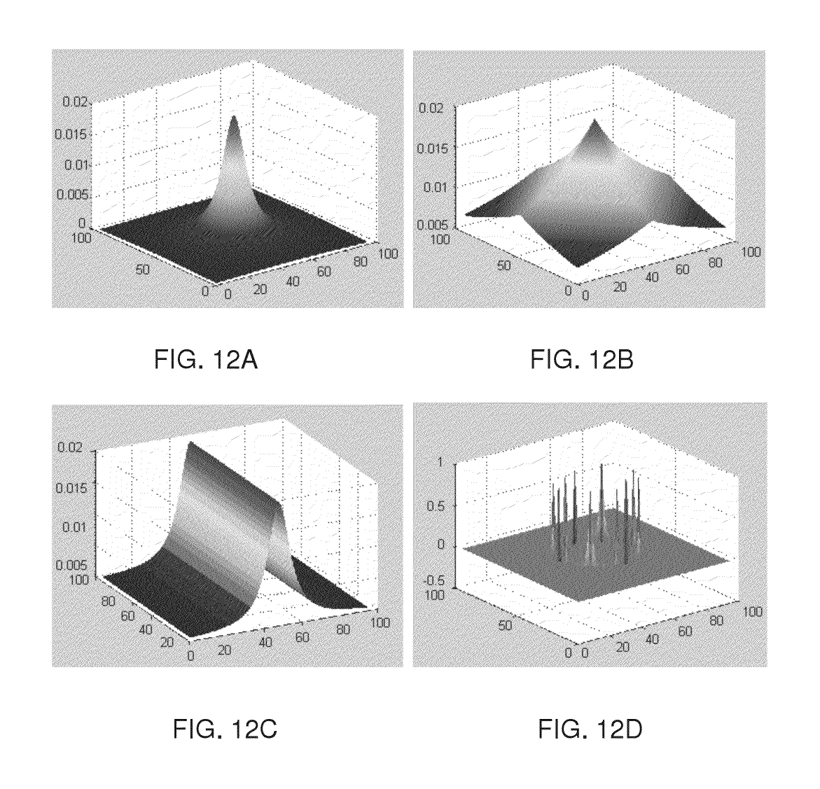

W(x, y)=1/(α+f(A−x)+f(B−y)) (EQ. 2)

where, α is a (positive) width parameter, A and B are center parameters and f is some non-negative function. Typical values for a are from about 0.1 to about 30. The value of A and B depend on the location of the respective domain. Preferably the point x=A, y=B is within the processed domain. The function f(u) is preferably selected such that it has a global minimum when its argument u vanishes. For example, in one embodiment f(u)=u² and in one embodiment f(u)=|u|. Typical shapes of the weight function formulated in EQ. 2 for f(u)=u² and f(u)=|u|, are is shown in FIGS. 12A and 12B, respectively.

In some embodiments two weight functions W₁(x) and W₂(y) are used, e.g.,

W₁(x)=1/(α+f(A−x)), W₂(y)=1/(α+f(B−y)) (EQ. 3)

where α, A, B and f have the same meaning as explained above. The weight functions effect a band-like weighting, either column-wise (W₁) or row-wise (W₂). A typical shape of W₁ for f(u)=u² is shown in FIG. 12C.

In some embodiments, W(x, y) has the form:

W(x, y)=1/(α+f(A−x)+f(B−y)−R²) (EQ. 4)

where α, A, B and f have the same meaning as explained above and R is a radius parameter. This weight function has maxima along a locus shaped as a circle centered at x=A, y=B, and decreases away from the circle. A typical shape of this weight function for f(u)=u² is shown in FIG. 12D.

In some embodiments one or more of the following set of step-like functions is used:

W(x, y)=1 for y<B and W(x, y)=1/α otherwise; (EQ. 5)

W(x, y)=1 for A<y<B and W(x, y)=1/α otherwise; (EQ. 6)

W(x, y)=1 for A<x<B and W(x, y)=1/α otherwise; and (EQ. 7)

W(x, y)=1 for x<A and W(x, y)=1/α otherwise; (EQ. 8)

where α, A and B have the same meaning as explained above. These functions can be effectively used for |B−A|<k where k=5, 6, . . . , 10. Increasing of the weight in the interval [A, B] allows the procedure to decrease the cylinder values. Outside the interval, the cylinder value is increasing.

Once all non-masked domains are processed, the procedure continues to decision 644 at which one or more stop criteria is applied. For example, the procedure can count the number of small cylinder values that were obtained, and determine that the stop criterion is met when the number of small cylinder values is below a predetermined threshold.

If the stop criterion is met, the procedure continues to 646 at which the procedure ends. If the stop criterion is not met, the method preferably continues to 645 at which the weight functions are updated. The advantage of this operation is that it allows passing local minima while maintaining the basic features obtained during the previous optimization stage.

In some embodiments of the present invention peripheral regions over the surface (e.g., regions for which the horizontal coordinate satisfies |x|>20 mm) are subjected to optimization separately than inner regions (e.g., regions for which |x|<20 mm). The surface optimization for the peripheral regions is preferably employed once the stopping criterion or set of criteria of the optimization of the inner regions is met.

The method ends at 66.

The PAL device of the present embodiments can be formed by any convenient method such as, but not limited to, thermoforming, molding, grinding, free-form grinding, free-form cutting, casting and the like.

For example, in some embodiments, a mold device which comprises a mold body shaped complementarily to lens body 22 (namely designed to provide the shape of the surfaces of lens body 22) is provided. Subsequently, a lens material is introduced into the mold device, and the progressive addition lens device is casted using the mold as known in the art. For example, a preform can be placed in juxtaposition with the molding surface of the mold. The preform can be produced by any convenient means including, without limitation, injection or injection-compression molding, thermoforming and casting. Subsequently, the progressive surface is casted onto the preform. Alternatively, a curable and injectable lens material such as, but not limited to, a polymerizable monomer or the like, can be injected into the mold and the PAL device can be casted using the mold. It is appreciated that the shape of the mold can include some compensations to take care of unwanted geometry changes, which may result from the bending and flowing of the lens material during the casting.

In some embodiments, a free forming fabrication apparatus is fed with properties of progressive power surface 24. The free forming fabrication apparatus can then be activated to form the surface on a lens body. The free forming fabrication apparatus can include a computer numerically-controlled (CNC) milling or grinding machine, such as the commercially available Schneider, Optotech and Dac machines. The apparatus can be fed with surface height data corresponding to the properties of surface 24. The surface height data can be preprocessed so as to fit to the particular CNC controller on the grinding or milling machine that is used. Some compensation can also be built into the surface geometry depending on the size and type of grinding tool or cutter that is used so as to ensure that the design surface is produced.

A free forming fabrication apparatus can also be used for producing a molding surface of a mold device which can thereafter be used for casting the PAL device of the present embodiments as further detailed hereinabove. In this embodiment, the apparatus is fed by complementary surface height data (also known as height data in concave form) and is then activated to form the mold device.

The PAL device of the present embodiments can be constructed of any known material suitable for production of ophthalmic lenses. Such materials may be constructed of any known material suitable for production of ophthalmic lenses. Such materials are either commercially available or methods for their production are known. When the PAL device is fabricated by molding, the lens material used to form the PAL device or preform may be any melt processable thermoplastic resin or a thermoset resin. Also contemplated is glass.

The PAL device of the present embodiments can be characterized by any value of base curve and any value of optical add power. Representative examples of base curves suitable for the present embodiments include, without limitation, any base curve from a minimal value of 1.00 diopter to a maximal value of 8.00 diopters in steps of, e.g., 0.25 diopters. Other values of base curves are also contemplated. Representative examples of optical add powers suitable for the present embodiments include, without limitation, any optical add power value from a minimal value of 0.25 diopters to a maximal value of 4.00 diopters, in steps of, e.g., 0.25 diopters. Other values of optical add powers are also contemplated.

The typical size of the lens body is, without limitation, about 80 mm in diameter. The lens body can have a circular outline but can also have other outlines. As part of any of the manufacturing procedure, the lens body may be shaped into a variety of outlines for a variety of spectacle frames.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Several PALs were designed according to some embodiments of the present invention. The optical powers of the PALs are described in Tables 1-6 below. The leftmost column in each table indicates the vertical coordinate y, in millimeters, where y=0 correspond to the 0-180 line with y<0 for the regions below the 0-180 line and y>0 for the regions above the 0-180 line. The topmost row in each table indicates the horizontal coordinate x, in millimeters, with x<0 for the temporal part and x>0 for the nasal part.

The vertical span of the near-viewing zone is approximately y≦−14, and vertical span of the far-viewing zone is approximately y≧2. The horizontal span of the near- and far-viewing zones depend on the base curve and optical add power.

TABLE 1
Base curve 4.50 diopters, optical add power 1.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 4.676 | 4.634 | 4.573 | 4.48 | 4.409 | 4.37 | 4.362 | 4.362 | 4.362 | 4.362 | 4.365 | 4.367 |
| 10 | 4.808 | 4.732 | 4.654 | 4.562 | 4.457 | 4.393 | 4.368 | 4.37 | 4.373 | 4.4 | 4.439 | 4.493 |
| 5 | 4.917 | 4.9 | 4.857 | 4.748 | 4.645 | 4.544 | 4.462 | 4.523 | 4.632 | 4.679 | 4.734 | 4.804 |
| 0 | 4.949 | 4.949 | 4.949 | 4.943 | 4.915 | 4.832 | 4.75 | 4.782 | 4.879 | 4.982 | 5.14 | 5.167 |
| −5 | 4.952 | 4.952 | 4.949 | 4.968 | 5.034 | 5.1 | 5.012 | 4.848 | 4.729 | 4.81 | 4.947 | 5.06 |
| −10 | 4.972 | 4.967 | 4.975 | 5.009 | 5.145 | 5.289 | 5.273 | 4.943 | 4.668 | 4.577 | 4.6 | 4.83 |
| −15 | 5.027 | 5.035 | 5.045 | 5.138 | 5.289 | 5.48 | 5.474 | 5.163 | 4.896 | 4.616 | 4.442 | 4.546 |

TABLE 2
Base curve 4.50 diopters, optical add power 2.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 4.87 | 4.832 | 4.74 | 4.488 | 4.427 | 4.382 | 4.366 | 4.366 | 4.367 | 4.367 | 4.368 | 4.42 |
| 10 | 5.05 | 4.937 | 4.865 | 4.711 | 4.56 | 4.455 | 4.401 | 4.413 | 4.441 | 4.471 | 4.48 | 4.539 |
| 5 | 5.35 | 5.315 | 5.197 | 5.029 | 4.847 | 4.675 | 4.597 | 4.697 | 4.768 | 4.846 | 4.932 | 5.054 |
| 0 | 5.411 | 5.411 | 5.408 | 5.398 | 5.327 | 5.159 | 4.999 | 5.088 | 5.177 | 5.316 | 5.468 | 5.637 |
| −5 | 5.424 | 5.415 | 5.409 | 5.444 | 5.538 | 5.624 | 5.46 | 5.271 | 5.097 | 5.153 | 5.32 | 5.489 |
| −10 | 5.442 | 5.43 | 5.442 | 5.54 | 5.772 | 6.029 | 5.892 | 5.34 | 4.866 | 4.664 | 4.813 | 5.127 |
| −15 | 5.72 | 5.737 | 5.744 | 5.845 | 6.067 | 6.355 | 6.308 | 5.707 | 4.968 | 4.396 | 4.347 | 4.487 |

TABLE 3
Base curve 4.50 diopters, optical add power 3.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 5.197 | 5.077 | 4.854 | 4.575 | 4.458 | 4.389 | 4.367 | 4.368 | 4.37 | 4.372 | 4.374 | 4.377 |
| 10 | 5.588 | 5.377 | 5.131 | 4.775 | 4.653 | 4.484 | 4.404 | 4.439 | 4.497 | 4.551 | 4.586 | 4.592 |
| 5 | 5.889 | 5.741 | 5.544 | 5.323 | 5.085 | 4.86 | 4.727 | 4.843 | 5.06 | 5.229 | 5.318 | 5.332 |
| 0 | 5.988 | 5.988 | 5.988 | 5.922 | 5.724 | 5.468 | 5.267 | 5.433 | 5.7 | 5.939 | 6.093 | 6.147 |
| −5 | 5.983 | 5.982 | 5.994 | 5.998 | 6.068 | 6.2 | 5.979 | 5.642 | 5.544 | 5.664 | 5.863 | 6.022 |
| −10 | 5.976 | 5.988 | 5.996 | 6.102 | 6.402 | 6.813 | 6.644 | 5.777 | 5.037 | 4.775 | 4.935 | 5.197 |
| −15 | 6.001 | 6.013 | 6.105 | 6.355 | 7.145 | 7.338 | 7.325 | 6.552 | 5.079 | 4.614 | 4.431 | 4.453 |

TABLE 4
Base curve 6.50 diopters, optical add power 1.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 6.417 | 6.356 | 6.271 | 6.181 | 6.087 | 6.049 | 6.04 | 6.04 | 6.04 | 6.04 | 6.042 | 6.044 |
| 10 | 6.472 | 6.447 | 6.377 | 6.294 | 6.162 | 6.062 | 6.06 | 6.077 | 6.098 | 6.109 | 6.128 | 6.136 |
| 5 | 6.535 | 6.508 | 6.486 | 6.435 | 6.325 | 6.201 | 6.129 | 6.199 | 6.278 | 6.347 | 6.394 | 6.413 |
| 0 | 6.553 | 6.553 | 6.553 | 6.549 | 6.541 | 6.507 | 6.428 | 6.472 | 6.624 | 6.674 | 6.789 | 6.834 |
| −5 | 6.555 | 6.561 | 6.571 | 6.581 | 6.639 | 6.724 | 6.639 | 6.541 | 6.498 | 6.535 | 6.682 | 6.747 |
| −10 | 6.561 | 6.568 | 6.586 | 6.627 | 6.752 | 6.945 | 6.884 | 6.604 | 6.304 | 6.248 | 6.299 | 6.379 |
| −15 | 6.567 | 6.575 | 6.593 | 6.663 | 6.849 | 7.099 | 7.074 | 6.713 | 6.316 | 6.006 | 5.97 | 6.076 |

TABLE 5
Base curve 6.50 diopters, optical add power 2.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 6.721 | 6.589 | 6.361 | 6.213 | 6.153 | 6.074 | 6.043 | 6.047 | 6.05 | 6.053 | 6.056 | 6.062 |
| 10 | 6.827 | 6.805 | 6.756 | 6.611 | 6.397 | 6.196 | 6.164 | 6.181 | 6.232 | 6.272 | 6.363 | 6.414 |
| 5 | 6.996 | 6.991 | 6.981 | 6.913 | 6.716 | 6.424 | 6.311 | 6.428 | 6.583 | 6.714 | 6.769 | 6.791 |
| 0 | 7.023 | 7.023 | 7.021 | 7.018 | 6.992 | 6.872 | 6.731 | 6.806 | 6.954 | 7.114 | 7.156 | 7.288 |
| −5 | 7.027 | 7.033 | 7.041 | 7.091 | 7.202 | 7.356 | 7.207 | 6.917 | 6.763 | 6.831 | 7.061 | 7.171 |
| −10 | 7.028 | 7.047 | 7.071 | 7.176 | 7.424 | 7.719 | 7.648 | 7.074 | 6.495 | 6.214 | 6.316 | 6.637 |
| −15 | 7.086 | 7.116 | 7.343 | 7.455 | 7.655 | 8.026 | 7.993 | 7.378 | 6.637 | 5.931 | 5.694 | 5.979 |

TABLE 6
Base curve 6.50 diopters, optical add power 3.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 6.963 | 6.796 | 6.588 | 6.374 | 6.212 | 6.09 | 6.044 | 6.047 | 6.053 | 6.061 | 6.067 | 6.073 |
| 10 | 7.349 | 7.169 | 6.898 | 6.72 | 6.474 | 6.264 | 6.186 | 6.197 | 6.277 | 6.336 | 6.377 | 6.506 |
| 5 | 7.527 | 7.482 | 7.293 | 7.196 | 6.954 | 6.57 | 6.421 | 6.636 | 6.782 | 6.873 | 6.953 | 6.964 |
| 0 | 7.593 | 7.592 | 7.572 | 7.556 | 7.48 | 7.286 | 7.138 | 7.283 | 7.473 | 7.703 | 7.77 | 7.806 |
| −5 | 7.588 | 7.623 | 7.636 | 7.684 | 7.802 | 7.996 | 7.839 | 7.402 | 7.319 | 7.4 | 7.507 | 7.625 |
| −10 | 7.584 | 7.627 | 7.696 | 7.833 | 8.11 | 8.516 | 8.432 | 7.313 | 6.717 | 6.453 | 6.629 | 6.982 |
| −15 | 7.606 | 7.657 | 7.751 | 8.039 | 8.439 | 8.961 | 8.948 | 8.049 | 6.764 | 5.973 | 5.896 | 6.52 |

Tables 1-6 demonstrate that in all exemplary designs, the optical power as a function of the horizontal coordinate x, particularly below the 0-180 line, reaches a local minimum only at the nasal part. At the temporal part, the dependence of the optical power on the horizontal coordinate x is a substantially monotonic for any vertical coordinate y. Namely, no local minimum as a function of x was obtained at the temporal part. Additionally, all local minima of the optical power as a function of x are also global minima, for the respective vertical coordinate. Specifically, the optical power as a function of the horizontal coordinate x reaches a minimum at x=15, x=20 and x=25, for y=−5, y=−10 and y=−15, respectively.

Additionally, at the temporal part, the optical power is substantially monotonic as a function of the vertical coordinate y. Namely, no local minima or maxima of the optical power as a function of y were obtained at the temporal part. At the nasal part, on the other hand, the optical power as a function of y exhibits local maxima and minima. Specifically, for any x≧15, the optical power as a function of y reaches a maximum at y=0. For x=15 (namely 15 mm from the main meridian at the nasal part), the optical power as a function of y exhibits a local minimum at y=−10. It is noted that more local minima may be present, e.g., in the vicinity of x=15.

The optical properties of the PAL of the present embodiments, as demonstrated in Tables 1-6, are substantially different from the optical properties of conventional PALs. Tables 7-12 below show conventional PAL designs.

TABLE 7
Base curve 4.50 diopters, optical add power 1.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 4.368 | 4.365 | 4.363 | 4.363 | 4.363 | 4.363 | 4.363 | 4.363 | 4.364 | 4.365 | 4.366 | 4.369 |
| 10 | 4.501 | 4.498 | 4.471 | 4.431 | 4.402 | 4.387 | 4.389 | 4.407 | 4.448 | 4.483 | 4.507 | 4.511 |
| 5 | 4.711 | 4.703 | 4.684 | 4.641 | 4.574 | 4.514 | 4.532 | 4.603 | 4.673 | 4.705 | 4.727 | 4.731 |
| 0 | 4.876 | 4.845 | 4.811 | 4.771 | 4.743 | 4.724 | 4.753 | 4.781 | 4.807 | 4.874 | 4.918 | 4.945 |
| −5 | 4.902 | 4.813 | 4.771 | 4.755 | 4.815 | 4.948 | 4.999 | 4.854 | 4.751 | 4.766 | 4.918 | 4.947 |
| −10 | 4.813 | 4.717 | 4.656 | 4.692 | 4.871 | 5.145 | 5.22 | 4.949 | 4.691 | 4.546 | 4.575 | 4.661 |
| −15 | 4.699 | 4.604 | 4.568 | 4.679 | 4.977 | 5.3 | 5.42 | 5.109 | 4.662 | 4.338 | 4.478 | 4.493 |

TABLE 8
Base curve 4.50 diopters, optical add power 2.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 4.377 | 4.375 | 4.373 | 4.371 | 4.369 | 4.366 | 4.366 | 4.369 | 4.372 | 4.376 | 4.377 | 4.378 |
| 10 | 4.524 | 4.497 | 4.482 | 4.468 | 4.43 | 4.399 | 4.402 | 4.44 | 4.471 | 4.495 | 4.518 | 4.519 |
| 5 | 4.968 | 4.921 | 4.87 | 4.788 | 4.682 | 4.593 | 4.605 | 4.742 | 4.872 | 4.983 | 5.038 | 5.047 |
| 0 | 5.344 | 5.333 | 5.265 | 5.122 | 5.005 | 4.971 | 5.013 | 5.082 | 5.26 | 5.432 | 5.527 | 5.587 |
| −5 | 5.393 | 5.294 | 5.178 | 5.071 | 5.093 | 5.389 | 5.501 | 5.126 | 5.01 | 5.181 | 5.453 | 5.713 |
| −10 | 5.196 | 4.958 | 4.811 | 4.841 | 5.182 | 5.826 | 6.018 | 5.297 | 4.757 | 4.545 | 4.85 | 5.181 |
| −15 | 4.985 | 4.693 | 4.55 | 4.774 | 5.379 | 6.142 | 6.378 | 5.64 | 4.761 | 4.23 | 4.372 | 4.65 |

TABLE 9
Base curve 4.50 diopters, optical add power 3.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 4.375 | 4.373 | 4.371 | 4.369 | 4.369 | 4.367 | 4.368 | 4.369 | 4.369 | 4.373 | 4.375 | 4.381 |
| 10 | 4.513 | 4.512 | 4.492 | 4.475 | 4.455 | 4.437 | 4.438 | 4.458 | 4.479 | 4.498 | 4.521 | 4.527 |
| 5 | 4.921 | 4.878 | 4.823 | 4.743 | 4.631 | 4.534 | 4.555 | 4.66 | 4.803 | 4.909 | 5.041 | 5.135 |
| 0 | 5.867 | 5.727 | 5.61 | 5.404 | 5.166 | 5.022 | 5.051 | 5.253 | 5.551 | 5.738 | 5.919 | 6.125 |
| −5 | 6.252 | 5.974 | 5.774 | 5.559 | 5.429 | 5.642 | 5.715 | 5.475 | 5.562 | 5.873 | 6.2 | 6.381 |
| −10 | 5.878 | 5.507 | 5.193 | 5.366 | 5.543 | 6.337 | 6.511 | 5.558 | 5.25 | 4.825 | 5.301 | 5.568 |
| −15 | 5.506 | 4.984 | 4.738 | 5.108 | 5.873 | 6.905 | 7.164 | 6.063 | 4.861 | 4.359 | 4.625 | 5.165 |

TABLE 10
Base curve 6.50 diopters, optical add power 1.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 6.047 | 6.042 | 6.04 | 6.04 | 6.04 | 6.04 | 6.04 | 6.04 | 6.04 | 6.04 | 6.043 | 6.047 |
| 10 | 6.116 | 6.11 | 6.092 | 6.069 | 6.047 | 6.04 | 6.04 | 6.057 | 6.085 | 6.11 | 6.126 | 6.118 |
| 5 | 6.365 | 6.331 | 6.296 | 6.258 | 6.189 | 6.121 | 6.131 | 6.201 | 6.282 | 6.331 | 6.369 | 6.389 |
| 0 | 6.582 | 6.543 | 6.505 | 6.478 | 6.368 | 6.32 | 6.343 | 6.404 | 6.521 | 6.569 | 6.62 | 6.639 |
| −5 | 6.616 | 6.555 | 6.499 | 6.452 | 6.457 | 6.56 | 6.603 | 6.464 | 6.414 | 6.465 | 6.655 | 6.654 |
| −10 | 6.561 | 6.475 | 6.391 | 6.448 | 6.528 | 6.795 | 6.869 | 6.541 | 6.373 | 6.223 | 6.319 | 6.432 |
| −15 | 6.483 | 6.388 | 6.294 | 6.35 | 6.629 | 6.935 | 7.081 | 6.671 | 6.344 | 6.133 | 6.175 | 6.283 |

TABLE 11
Base curve 6.50 diopters, optical add power 2.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 6.066 | 6.059 | 6.051 | 6.041 | 6.041 | 6.04 | 6.04 | 6.042 | 6.043 | 6.053 | 6.062 | 6.073 |
| 10 | 6.202 | 6.194 | 6.164 | 6.119 | 6.067 | 6.038 | 6.043 | 6.079 | 6.149 | 6.194 | 6.217 | 6.237 |
| 5 | 6.573 | 6.532 | 6.501 | 6.408 | 6.282 | 6.189 | 6.211 | 6.36 | 6.488 | 6.603 | 6.643 | 6.677 |
| 0 | 6.823 | 6.798 | 6.722 | 6.686 | 6.613 | 6.552 | 6.597 | 6.681 | 6.787 | 6.856 | 6.925 | 6.956 |
| −5 | 7.031 | 6.824 | 6.809 | 6.771 | 6.789 | 6.985 | 7.059 | 6.821 | 6.681 | 6.769 | 6.847 | 7.155 |
| −10 | 6.754 | 6.617 | 6.641 | 6.684 | 6.894 | 7.406 | 7.526 | 6.949 | 6.505 | 6.37 | 6.425 | 6.576 |
| −15 | 6.694 | 6.624 | 6.521 | 6.631 | 7.1 | 7.76 | 7.911 | 7.273 | 6.569 | 6.216 | 6.234 | 6.359 |

TABLE 12
Base curve 6.50 diopters, optical add power 3.00

| Temporal Part | | | | | | | Nasal Part | | | | | |
|---|---|---|---|---|---|---|---|---|---|---|---|---|
| | −30 | −25 | −20 | −15 | −10 | −5 | 5 | 10 | 15 | 20 | 25 | 30 |
| 15 | 6.069 | 6.058 | 6.051 | 6.041 | 6.039 | 6.039 | 6.039 | 6.039 | 6.042 | 6.053 | 6.062 | 6.076 |
| 10 | 6.254 | 6.241 | 6.221 | 6.191 | 6.118 | 6.066 | 6.072 | 6.119 | 6.201 | 6.249 | 6.269 | 6.293 |
| 5 | 6.894 | 6.875 | 6.802 | 6.671 | 6.513 | 6.395 | 6.417 | 6.565 | 6.764 | 6.952 | 7.076 | 7.125 |
| 0 | 7.709 | 7.596 | 7.426 | 7.195 | 7.012 | 6.988 | 7.043 | 7.102 | 7.317 | 7.533 | 7.891 | 8.004 |
| −5 | 7.858 | 7.633 | 7.373 | 7.131 | 7.173 | 7.611 | 7.741 | 7.267 | 7.101 | 7.396 | 7.704 | 8.029 |
| −10 | 7.402 | 7.111 | 6.772 | 6.944 | 7.383 | 8.182 | 8.369 | 7.475 | 6.766 | 6.482 | 6.741 | 7.325 |
| −15 | 7.051 | 6.563 | 6.424 | 6.728 | 7.611 | 8.652 | 8.941 | 8.052 | 6.892 | 6.089 | 6.185 | 6.742 |

Tables 7-12 demonstrate that conventional designs are generally symmetric. Specifically, as a function of x, the optical power, particularly at and below the 0-180 line, reaches local minima at both the nasal and temporal parts; and as a function of y the optical power, particularly at a distance of more than 10 mm from the main meridian, reaches local maxima at both the nasal and temporal parts.

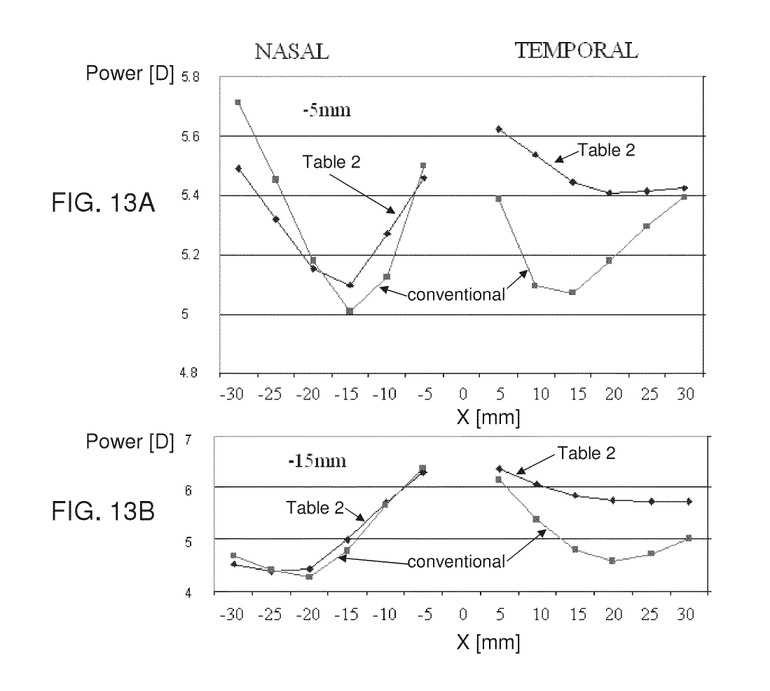

FIGS. 13A and 13B display a comparison between conventional design and the design according to some embodiments of the present invention, for base curve 4.50 diopters and optical add power 2.00 (data taken from Table 2 and Table 8). Shown in FIGS. 13A and 13B is the optical power as a function of x for y=−5 (FIG. 13A) and y=−15 (FIG. 13B). As shown, at the temporal part, the optical power is substantially monotonic (deviation of less than 1%) for the design of the present embodiments and non-monotonic for conventional design.

Tables 13-18 below display the asymmetry matrices corresponding to the designs described in Tables 1-6. The leftmost column in each table indicates the vertical coordinate y, in millimeters, as in Tables 1-12 above. The topmost row in each table indicates the horizontal coordinates of the respective antipodal pair. The value displayed in each internal entry in Tables 13-18 indicate the difference in optical power for the respective antipodal pair.

TABLE 13
Base curve 4.50 diopters, optical add power 1.00

| | −5; 5 | −10; 10 | −15; 15 | −20; 20 | −25; 25 | −30; 30 |
|---|---|---|---|---|---|---|
| 15 | 0.008 | 0.047 | 0.118 | 0.211 | 0.269 | 0.309 |
| 10 | 0.025 | 0.087 | 0.189 | 0.254 | 0.293 | 0.315 |
| 5 | 0.082 | 0.122 | 0.116 | 0.178 | 0.166 | 0.113 |
| 0 | 0.082 | 0.133 | 0.064 | −0.033 | −0.191 | −0.218 |
| −5 | 0.088 | 0.186 | 0.239 | 0.139 | 0.005 | −0.108 |
| −10 | 0.016 | 0.202 | 0.341 | 0.398 | 0.367 | 0.142 |
| −15 | 0.006 | 0.126 | 0.242 | 0.429 | 0.593 | 0.481 |

TABLE 14
Base curve 4.50 diopters, optical add power 2.00

| | −5; 5 | −10; 10 | −15; 15 | −20; 20 | −25; 25 | −30; 30 |
|---|---|---|---|---|---|---|
| 15 | 0.016 | 0.061 | 0.121 | 0.373 | 0.464 | 0.45 |
| 10 | 0.054 | 0.147 | 0.270 | 0.394 | 0.457 | 0.5112 |
| 5 | 0.078 | 0.150 | 0.261 | 0.351 | 0.383 | 0.296 |
| 0 | 0.160 | 0.239 | 0.221 | 0.092 | −0.06 | −0.23 |
| −5 | 0.164 | 0.267 | 0.347 | 0.256 | 0.095 | −0.06 |
| −10 | 0.137 | 0.432 | 0.674 | 0.778 | 0.617 | 0.315 |
| −15 | 0.047 | 0.360 | 0.877 | 1.348 | 1.390 | 1.233 |

TABLE 15
Base curve 4.50 diopters, optical add power 3.00

| | −5; 5 | −10; 10 | −15; 15 | −20; 20 | −25; 25 | −30; 30 |
|---|---|---|---|---|---|---|
| 15 | 0.022 | 0.09 | 0.205 | 0.482 | 0.703 | 0.82 |
| 10 | 0.08 | 0.214 | 0.278 | 0.58 | 0.791 | 0.996 |
| 5 | 0.133 | 0.242 | 0.263 | 0.315 | 0.423 | 0.557 |
| 0 | 0.201 | 0.291 | 0.222 | 0.049 | −0.11 | −0.16 |
| −5 | 0.221 | 0.426 | 0.454 | 0.33 | 0.119 | −0.04 |
| −10 | 0.169 | 0.625 | 1.065 | 1.221 | 1.053 | 0.779 |
| −15 | 0.013 | 0.593 | 1.276 | 1.491 | 1.582 | 1.548 |

TABLE 16
Base curve 6.50 diopters, optical add power 1.00

| | −5; 5 | −10; 10 | −15; 15 | −20; 20 | −25; 25 | −30; 30 |
|---|---|---|---|---|---|---|
| 15 | 0.009 | 0.047 | 0.141 | 0.231 | 0.314 | 0.373 |
| 10 | 0.002 | 0.085 | 0.196 | 0.268 | 0.319 | 0.336 |
| 15 | 0.072 | 0.126 | 0.157 | 0.139 | 0.114 | 0.122 |
| 0 | 0.079 | 0.069 | −0.075 | −0.121 | −0.236 | −0.281 |
| −5 | 0.085 | 0.098 | 0.083 | 0.036 | −0.121 | −0.192 |
| −10 | 0.061 | 0.148 | 0.323 | 0.338 | 0.269 | 0.182 |
| −15 | 0.025 | 0.136 | 0.347 | 0.587 | 0.605 | 0.491 |

TABLE 17
Base curve 6.50 diopters, optical add power 2.00

| | −5; 5 | −10; 10 | −15; 15 | −20; 20 | −25; 25 | −30; 30 |
|---|---|---|---|---|---|---|
| 15 | 0.031 | 0.106 | 0.163 | 0.308 | 0.533 | 0.659 |
| 10 | 0.032 | 0.216 | 0.379 | 0.484 | 0.442 | 0.413 |
| 5 | 0.113 | 0.288 | 0.330 | 0.267 | 0.222 | 0.205 |
| 0 | 0.141 | 0.186 | 0.064 | −0.093 | −0.133 | −0.27 |
| −5 | 0.149 | 0.285 | 0.328 | 0.210 | −0.028 | −0.14 |
| −10 | 0.071 | 0.350 | 0.681 | 0.857 | 0.731 | 0.391 |
| −15 | 0.033 | 0.277 | 0.818 | 1.412 | 1.422 | 1.107 |

TABLE 18
Base curve 6.50 diopters, optical add power 3.00

| | −5; 5 | −10; 10 | −15; 15 | −20; 20 | −25; 25 | −30; 30 |
|---|---|---|---|---|---|---|
| 15 | 0.046 | 0.165 | 0.321 | 0.527 | 0.729 | 0.89 |
| 10 | 0.078 | 0.277 | 0.443 | 0.562 | 0.792 | 0.843 |
| 5 | 0.149 | 0.318 | 0.414 | 0.42 | 0.529 | 0.563 |
| 0 | 0.148 | 0.197 | 0.083 | −0.13 | −0.18 | −0.21 |
| −5 | 0.157 | 0.4 | 0.365 | 0.236 | 0.116 | −0.04 |
| −10 | 0.084 | 0.797 | 1.116 | 1.243 | 0.998 | 0.602 |
| −15 | 0.013 | 0.39 | 1.275 | 1.778 | 1.761 | 1.086 |

Tables 13-18 demonstrate that for any base curve and optical add power there are at least some entries which are more than one fifth of the optical add power. As demonstrated, in all designs, the asymmetry is pronounced in the near-viewing zone as well as in the far-viewing zone. In the near-viewing zone the asymmetry is more pronounced, with at least a few entries above half the optical add power of the PAL. In the far-viewing zone, 85% of the entries are above 0.04 diopters and 50% of the entries are above 0.2 diopters.

The asymmetry matrix of the PAL of the present embodiments, as demonstrated in Tables 13-18 is substantially different from the asymmetry matrix of conventional PALs. Tables 19-25 below show conventional PAL designs.

TABLE 19
Base curve 4.50 diopters, optical add power 1.00

| | −5; 5 | −10; 10 | −15; 15 | −20; 20 | −25; 25 | −30; 30 |
|---|---|---|---|---|---|---|
| 15 | 0 | 0 | −0 | −0 | −0 | −0 |
| 10 | −0 | −0 | −0.02 | −0.01 | −0.01 | −0.01 |
| 5 | −0.02 | −0.03 | −0.03 | −0.02 | −0.02 | −0.02 |
| 0 | −0.03 | −0.04 | −0.04 | −0.06 | −0.07 | −0.07 |
| −5 | −0.05 | −0.04 | 0.004 | 0.005 | −0.11 | −0.04 |
| −10 | −0.08 | −0.08 | 0.001 | 0.11 | 0.142 | 0.152 |
| −15 | −0.12 | −0.13 | 0.017 | 0.23 | 0.126 | 0.206 |

TABLE 20
Base curve 4.50 diopters, optical add power 2.00

| | −5; 5 | −10; 10 | −15; 15 | −20; 20 | −25; 25 | −30; 30 |
|---|---|---|---|---|---|---|
| 15 | 0 | 0 | −0 | −0.003 | −0 | −0 |
| 10 | −0 | −0.01 | −0 | −0.013 | −0.02 | 0.005 |
| 5 | −0.01 | −0.06 | −0.08 | −0.113 | −0.12 | −0.08 |
| 0 | −0.04 | −0.08 | −0.14 | −0.167 | −0.19 | −0.24 |
| −5 | −0.11 | −0.03 | 0.061 | −0.003 | −0.16 | −0.32 |
| −10 | −0.19 | −0.12 | 0.084 | 0.266 | 0.108 | 0.015 |
| −15 | −0.24 | −0.26 | 0.013 | 0.320 | 0.321 | 0.335 |

TABLE 21
Base curve 4.50 diopters, optical add power 3.00

| | −5;5 | −10;10 | −15;15 | −20;20 − | 25;25 | −30;30 |
|---|---|---|---|---|---|---|
| 15 | −0 | 0 | 0 | −0 | −0 | −0.01 |
| 10 | −0 | −0 | −0 | −0.01 | −0.01 | −0.01 |
| 5 | −0.02 | −0.03 | −0.06 | −0.09 | −0.16 | −0.21 |
| 0 | −0.03 | −0.09 | −0.15 | −0.13 | −0.19 | −0.26 |
| −5 | −0.07 | −0.05 | −0 | −0.1 | −0.23 | −0.13 |
| −10 | −0.17 | −0.01 | 0.116 | 0.368 | 0.206 | 0.31 |
| −15 | −0.26 | −0.19 | 0.247 | 0.379 | 0.359 | 0.341 |

TABLE 22
Base curve 6.50 diopters, optical add power 1.00

| | −5;5 | −10;10 | −15;15 | −20;20 | −25;25 | −30;30 |
|---|---|---|---|---|---|---|
| 15 | 0 | 0 | 0 | 0 | −0 | 0 |
| 10 | 0 | −0.01 | −0.02 | −0.02 | −0.02 | −0 |
| 5 | −0.01 | −0.01 | −0.02 | −0.04 | −0.04 | −0.02 |
| 0 | −0.02 | −0.04 | −0.04 | −0.06 | −0.08 | −0.06 |
| −5 | −0.04 | −0.01 | 0.038 | 0.034 | −0.1 | −0.04 |
| −10 | −0.07 | −0.01 | 0.075 | 0.168 | 0.156 | 0.129 |
| −15 | −0.15 | −0.04 | 0.006 | 0.161 | 0.213 | 0.2 |

TABLE 23
Base curve 6.50 diopters, optical add power 2.00

| | −5;5 | −10;10 | −15;15 | −20;20 | −25;25 | −30;30 |
|---|---|---|---|---|---|---|
| 15 | 0 | −0 | −0 | −0.002 | −0 | −0.01 |
| 10 | −0 | −0.01 | −0.03 | −0.030 | −0.02 | −0.03 |
| 5 | −0.02 | −0.08 | −0.08 | −0.102 | −0.11 | −0.1 |
| 0 | −0.04 | −0.07 | −0.1 | −0.134 | −0.13 | −0.13 |
| −5 | −0.07 | −0.03 | 0.09 | 0.040 | −0.02 | −0.12 |
| −10 | −0.12 | −0.06 | 0.179 | 0.271 | 0.192 | 0.178 |
| −15 | −0.15 | −0.17 | 0.062 | 0.305 | 0.39 | 0.335 |

TABLE 24
Base curve 6.50 diopters, optical add power 3.00

| | −5;5 | −10;10 | −15;15 | −20;20 − | 25;25 | −30;30 |
|---|---|---|---|---|---|---|
| 15 | 0 | 0 | −0 | −0 | −0 | −0.01 |
| 10 | −0.01 | −0 | −0.01 | −0.03 | −0.03 | −0.04 |
| 5 | −0.02 | −0.05 | −0.09 | −0.15 | −0.2 | −0.23 |
| 0 | −0.06 | −0.09 | −0.12 | −0.11 | −0.29 | −0.3 |
| −5 | −0.13 | −0.09 | 0.03 | −0.02 | −0.07 | −0.17 |
| −10 | −0.19 | −0.09 | 0.178 | 0.29 | 0.37 | 0.077 |
| −15 | −0.29 | −0.44 | −0.16 | 0.335 | 0.378 | 0.309 |

Tables 19-24 demonstrate that the conventional designs are generally symmetric. At the far-viewing zones, all entries in the asymmetry matrix are consistent with zero. There are non-zero entries but they are much smaller than those obtained for the PALs of the present embodiments. Specifically, all entries in the asymmetry matrix of the conventional PALs are below a quarter of the optical add power.

Table 25 displays the difference in optical power between conventional design the design according to some embodiments of the present invention, for base curve 4.50 diopters and optical add power 2.00 (difference between Table 2 and Table 8).

TABLE 25
Temporal

| | −30 | −25 | −20 | −15 | −10 | −5 |
|---|---|---|---|---|---|---|
| 15 | 0.493 | 0.457 | 0.367 | 0.117 | 0.058 | 0.016 |
| 10 | 0.526 | 0.44 | 0.383 | 0.243 | 0.13 | 0.056 |
| 5 | 0.382 | 0.394 | 0.327 | 0.241 | 0.165 | 0.082 |
| 0 | 0.067 | 0.078 | 0.143 | 0.276 | 0.322 | 0.188 |
| −5 | 0.031 | 0.121 | 0.231 | 0.373 | 0.445 | 0.235 |
| −10 | 0.246 | 0.472 | 0.631 | 0.699 | 0.59 | 0.203 |
| −15 | 0.735 | 1.044 | 1.194 | 1.071 | 0.688 | 0.213 |

Nasal

| | 5 | 10 | 15 | 20 | 25 | 30 |
|---|---|---|---|---|---|---|
| 15 | 0 | −0 | −0 | −0.01 | −0.01 | 0.042 |
| 10 | −0 | −0.03 | −0.03 | −0.02 | −0.04 | 0.02 |
| 5 | −0.01 | −0.04 | −0.1 | −0.14 | −0.11 | 0.007 |
| 0 | −0.01 | 0.006 | −0.08 | −0.12 | −0.06 | 0.05 |
| −5 | −0.04 | 0.145 | 0.087 | −0.03 | −0.13 | −0.22 |
| −10 | −0.13 | 0.043 | 0.109 | 0.119 | −0.04 | −0.05 |
| −15 | −0.07 | 0.067 | 0.207 | 0.166 | −0.02 | −0.16 |

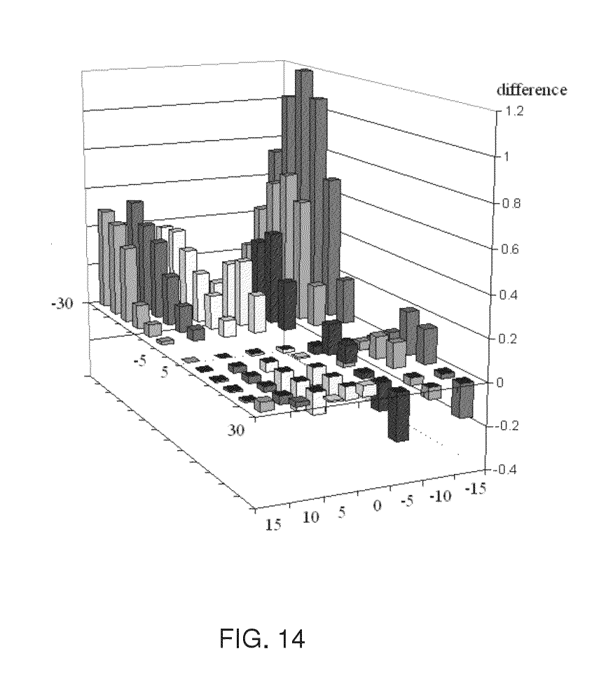

As demonstrated, the differences are substantial (from −0.22 to 0.207). A three-dimensional visualization of Table 25 is shown in FIG. 14.

Some cylinder values of the inventive PALs of Tables 1-3 are described in Tables 26-28 below.

TABLE 26
Base curve 4.50 diopters, optical add power 1.00
Temporal Part

| | −30 | −25 | −20 | −15 | −10 | −5 |
|---|---|---|---|---|---|---|
| 8 | 0.608 | 0.583 | 0.521 | 0.303 | 0.135 | 0.111 |
| 0 | 0.784 | 0.8 | 0.794 | 0.746 | 0.698 | 0.572 |
| −14 | 0.904 | 0.904 | 0.884 | 0.708 | 0.43 | 0.107 |

Nasal Part

| | 5 | 10 | 15 | 20 | 25 | 30 |
|---|---|---|---|---|---|---|
| 8 | 0.053 | 0.058 | 0.098 | 0.11 | 0.112 | 0.114 |
| 0 | 0.625 | 0.951 | 1.229 | 1.412 | 1.471 | 1.44 |
| −14 | 0.055 | 0.278 | 0.887 | 1.251 | 1.569 | 1.611 |

TABLE 27
Base curve 4.50 diopters, optical add power 2.00
Temporal Part

| | −30 | −25 | −20 | −15 | −10 | −5 |
|---|---|---|---|---|---|---|
| 8 | 1.329 | 1.294 | 1.106 | 0.978 | 0.681 | 0.148 |
| 0 | 1.564 | 1.689 | 1.689 | 1.586 | 1.244 | 0.898 |
| −14 | 2.108 | 2.105 | 1.956 | 1.649 | 0.976 | 0.288 |

Nasal Part

| | 5 | 10 | 15 | 20 | 25 | 30 |
|---|---|---|---|---|---|---|
| 8 | 0.01 | 0.125 | 0.388 | 0.587 | 0.634 | 0.699 |
| 0 | 1.111 | 2.231 | 2.408 | 2.475 | 2.523 | 2.555 |
| −14 | 0.194 | 0.597 | 1.263 | 2.387 | 2.765 | 3.09 |

TABLE 28
Base curve 4.50 diopters, optical add power 3.00
Temporal Part

| | −30 | −25 | −20 | −15 | −10 | −5 |
|---|---|---|---|---|---|---|
| 8 | 1.7 | 1.7 | 1.66 | 1.427 | 0.918 | 0.179 |
| 0 | 2.245 | 2.245 | 2.24 | 2.14 | 2.043 | 1.227 |
| −14 | 2.678 | 2.678 | 2.677 | 2.483 | 1.167 | 0.271 |

Nasal Part

| | 5 | 10 | 15 | 20 | 25 | 30 |
|---|---|---|---|---|---|---|
| 8 | 0.022 | 0.135 | 0.488 | 0.787 | 1.101 | 1.11 |
| 0 | 1.244 | 2.231 | 3.01 | 3.113 | 3.131 | 3.132 |
| −14 | 0.224 | 0.76 | 1.576 | 2.788 | 3.95 | 4.39 |

As demonstrated in Tables 26-28, the PAL of the present embodiments is asymmetric with respect to the main meridian. For any x in the nasal part, the cylinder value at y=8 mm (far-viewing zone) is less than 1 diopters for optical add powers of 1 diopter (Table 26) and 2 diopters (Table 27), and less than 1.2 diopters for optical add power of 3 diopters (Table 28). On the other hand, there are several locations in the temporal part (see x=−30 mm, −25 mm and −20 mm) for which the cylinder value at y=8 mm is at least 50% of the optical add power.

Some cylinder values of the conventional PAL of Table 14 are described in Table 29.

TABLE 29
Base curve 4.50 diopters, optical add power 2.00
Temporal Part

| | −30 | −25 | −20 | −15 | −10 | −5 |
|---|---|---|---|---|---|---|
| 8 | 0.409 | 0.405 | 0.391 | 0.286 | 0.155 | 0.022 |
| 0 | 2.076 | 2.114 | 2.116 | 2.187 | 1.766 | 1.09 |
| −14 | 1.842 | 2.208 | 2.576 | 2.637 | 1.887 | 0.513 |

Nasal Part

| | 5 | 10 | 15 | 20 | 25 | 30 |
|---|---|---|---|---|---|---|
| 8 | 0.03 | 0.188 | 0.324 | 0.46 | 0.475 | 0.487 |
| 0 | 1.126 | 1.975 | 2.296 | 2.418 | 2.576 | 2.506 |
| −14 | 0.286 | 1.215 | 2.67 | 3.06 | 2.586 | 1.877 |

Table 29 demonstrates that unlike the PAL of the present embodiments, the conventional PAL has low cylindrical values (less than 25% of the optical add power) at y=8 mm in both the temporal and nasal parts.

Tables 30 and 31 below display the cylinder asymmetry matrices corresponding to the designs described in Tables 27 and 29, respectively.

TABLE 30
Base curve 4.50 diopters, optical add power 2.00 (cf. TABLE 27)

| | −5;5 | −10;10 | −15;15 | −20;20 | −25;25 | −30;30 |
|---|---|---|---|---|---|---|
| 8 | 0.138 | 0.556 | 0.59 | 0.519 | 0.66 | 0.63 |
| 0 | −0.213 | −0.987 | −0.822 | −0.786 | −0.834 | −0.991 |
| −14 | 0.094 | 0.379 | 0.386 | −0.431 | −0.66 | −0.982 |

TABLE 31
Base curve 4.50 diopters, optical add power 2.00 (cf. TABLE 29)

| | −5;5 | −10;10 | −15;15 | −20;20 | −25;25 | −30;30 |
|---|---|---|---|---|---|---|
| 8 | −0.008 | −0.033 | −0.038 | −0.069 | −0.07 | −0.078 |
| 0 | −0.036 | −0.209 | −0.109 | −0.302 | −0.462 | −0.43 |
| −14 | 0.227 | 0.672 | −0.033 | −0.484 | −0.378 | −0.035 |

As demonstrated the cylinder asymmetry matrix of the PAL of the present embodiments (Table 30) is substantially different from the cylinder asymmetry matrix of the conventional PAL (Table 31). In particular, for y=8 mm the PAL of the present embodiments possesses a high level of asymmetry (differences in cylinder values of more than 0.5 diopters for any |x|>10 mm), while the conventional PAL is generally symmetric (differences in cylinder values which are consistent with zero).

Tables 32-38 below summarize the optical powers as a function of the polar angle, for base curve of 4.5 D and three different distances from the geometrical center of the PAL: R=10 mm, R=20 mm and R=30 mm. Each Table corresponds to a different optical add power. The data in Tables 32-34 is plotted in FIGS. 4A-C, the data in Tables 35-37 is plotted in FIGS. 4D-F, and the data in Table 38 is plotted in FIG. 5.

TABLE 32
Base curve 4.50 diopters, optical add power 1.00

| Angle | R = 10 | R = 20 | R = 30 |
|---|---|---|---|
| 0 | 4.782 | 4.982 | 5.167 |
| 22.5 | 4.535 | 4.417 | 4.401 |
| 45 | 4.426 | 4.386 | 4.383 |
| 67.5 | 4.369 | 4.384 | 4.382 |
| 90 | 4.366 | 4.384 | 4.382 |
| 112.5 | 4.396 | 4.428 | 4.432 |
| 135 | 4.554 | 4.568 | 4.599 |
| 157.5 | 4.689 | 4.696 | 4.709 |
| 180 | 4.915 | 4.949 | 4.949 |
| 202.5 | 5.012 | 4.979 | 4.981 |
| 225 | 5.172 | 5.11 | 5.097 |
| 247.5 | 5.296 | 5.301 | 5.315 |
| 270 | 5.321 | 5.374 | 5.391 |
| 292.5 | 5.049 | 5.094 | 5.013 |
| 315 | 5 | 4.832 | 4.422 |
| 337.5 | 4.889 | 4.583 | 4.418 |

TABLE 33
Base curve 4.50 diopters, optical add power 2.00

| Angle | R = 10 | R = 20 | R = 30 |
|---|---|---|---|
| 0 | 5.088 | 5.316 | 5.637 |
| 22.5 | 4.796 | 4.513 | 4.429 |
| 45 | 4.54 | 4.377 | 4.391 |
| 67.5 | 4.413 | 4.381 | 4.386 |
| 90 | 4.399 | 4.378 | 4.387 |
| 112.5 | 4.508 | 4.461 | 4.427 |
| 135 | 4.737 | 4.689 | 4.696 |
| 157.5 | 5.156 | 5.084 | 5.228 |
| 180 | 5.327 | 5.408 | 5.411 |
| 202.5 | 5.568 | 5.46 | 5.483 |
| 225 | 5.855 | 5.658 | 5.628 |
| 247.5 | 5.981 | 6.005 | 6.168 |
| 270 | 6.271 | 6.335 | 6.395 |
| 292.5 | 5.891 | 5.978 | 6.026 |
| 315 | 5.593 | 4.963 | 4.651 |
| 337.5 | 5.277 | 4.678 | 4.592 |

TABLE 34
Base curve 4.50 diopters, optical add power 3.00

| Angle | R = 10 | R = 20 | R = 30 |
|---|---|---|---|
| 0 | 5.433 | 5.939 | 6.147 |
| 22.5 | 5.052 | 4.709 | 4.483 |
| 45 | 4.644 | 4.415 | 4.386 |
| 67.5 | 4.477 | 4.387 | 4.381 |
| 90 | 4.415 | 4.387 | 4.389 |
| 112.5 | 4.592 | 4.473 | 4.789 |
| 135 | 4.913 | 4.875 | 5.039 |
| 157.5 | 5.374 | 5.56 | 5.522 |
| 180 | 5.724 | 5.988 | 5.988 |
| 202.5 | 6.044 | 6.097 | 6.016 |
| 225 | 6.391 | 6.349 | 6.313 |
| 247.5 | 6.814 | 7.014 | 7.11 |
| 270 | 7.298 | 7.367 | 7.391 |
| 292.5 | 6.747 | 6.877 | 6.806 |
| 315 | 6.065 | 5.277 | 4.991 |
| 337.5 | 5.659 | 5.118 | 4.967 |

TABLE 35
Base curve 4.50 diopters, optical add power 1.00
(Temporal Part)

| Angle | R = 10 | R = 20 | R = 30 |
|---|---|---|---|
| 90 | 4.366 | 4.384 | 4.382 |
| 112.5 | 4.396 | 4.428 | 4.432 |
| 135 | 4.554 | 4.568 | 4.599 |
| 157.5 | 4.689 | 4.696 | 4.709 |
| 180 | 4.915 | 4.949 | 4.949 |
| 202.5 | 5.012 | 4.979 | 4.981 |
| 225 | 5.172 | 5.11 | 5.097 |
| 247.5 | 5.296 | 5.301 | 5.315 |
| 270 | 5.321 | 5.374 | 5.391 |

TABLE 36
Base curve 4.50 diopters, optical add power 2.00
(Temporal Part)

| Angle | R = 10 | R = 20 | R = 30 |
|---|---|---|---|
| 90 | 4.399 | 4.378 | 4.387 |
| 112.5 | 4.508 | 4.461 | 4.427 |
| 135 | 4.737 | 4.689 | 4.696 |
| 157.5 | 5.156 | 5.084 | 5.228 |
| 180 | 5.327 | 5.408 | 5.411 |
| 202.5 | 5.568 | 5.46 | 5.483 |
| 225 | 5.855 | 5.658 | 5.628 |
| 247.5 | 5.981 | 6.005 | 6.168 |
| 270 | 6.271 | 6.335 | 6.395 |

TABLE 37
Base curve 4.50 diopters, optical add power 3.00
(Temporal Part)

| Angle | R = 10 | R = 20 | R = 30 |
|---|---|---|---|
| 90 | 4.415 | 4.387 | 4.389 |
| 112.5 | 4.592 | 4.473 | 4.789 |
| 135 | 4.913 | 4.875 | 5.039 |
| 157.5 | 5.374 | 5.56 | 5.522 |
| 180 | 5.724 | 5.988 | 5.988 |
| 202.5 | 6.044 | 6.097 | 6.016 |
| 225 | 6.391 | 6.349 | 6.313 |
| 247.5 | 6.814 | 7.014 | 7.11 |
| 270 | 7.298 | 7.367 | 7.391 |

TABLE 38
Base curve 4.50 diopters, Distance R = 30 mm
(Nasal Part)

| Angle | ADD = 1 D | ADD = 2 D | ADD = 3 D |
|---|---|---|---|
| 270 | 5.391 | 6.395 | 7.391 |
| 292.5 | 5.013 | 6.026 | 6.806 |
| 315 | 4.422 | 4.651 | 4.991 |
| 337.5 | 4.418 | 4.592 | 4.967 |
| 0 | 5.167 | 5.637 | 6.147 |
| 22.5 | 4.401 | 4.429 | 4.483 |
| 45 | 4.383 | 4.391 | 4.386 |
| 67.5 | 4.382 | 4.386 | 4.381 |
| 90 | 4.382 | 4.387 | 4.389 |

Tables 39A-B and 40A-B summarize slopes values (∂P/∂y) suitable for some embodiments of the present invention. The slopes were estimated in steps of 5 mm using optical values for base curve of 4.50 D and optical add power of 1.00 D, 2.00 D and 3.00 D, base curve of 6.50 D and optical add power of 2.00 D, and base curve of 2.50 D and optical add power of 2.00 D. A three-dimensional representation of the slope in 1 mm steps for a base curve of 4.50 D and optical add power of 2.00 D is shown in FIG. 16.

TABLE 39A
Slopes for base curve 4.50 diopters and optical add power 1.00
(0≦x≦30)

| | 0 | 5 | 10 | 15 | 20 | 25 | 30 |
|---|---|---|---|---|---|---|---|
| 10 | −0.0012 | −0.0012 | −0.0016 | −0.0022 | −0.0076 | −0.0148 | −0.0252 |
| 5 | −0.0206 | −0.0188 | −0.0306 | −0.0518 | −0.0558 | −0.059 | −0.0622 |
| 0 | −0.0598 | −0.0576 | −0.0518 | −0.0494 | −0.0606 | −0.0812 | −0.0726 |
| −5 | −0.056 | −0.0524 | −0.0132 | 0.03 | 0.0344 | 0.0386 | 0.0214 |
| −10 | −0.0458 | −0.0522 | −0.019 | 0.0122 | 0.0466 | 0.0694 | 0.046 |
| −15 | −0.04 | −0.0402 | −0.044 | −0.0456 | −0.0078 | 0.0316 | 0.0568 |

TABLE 39B
Slopes for base curve 4.50 diopters and optical add power 1.00
(−30≦x≦0)

| | −30 | −25 | −20 | −15 | −10 | −5 | 0 |
|---|---|---|---|---|---|---|---|
| 10 | −0.0264 | −0.0196 | −0.0162 | −0.0164 | −0.0096 | −0.0046 | −0.0012 |
| 5 | −0.0218 | −0.0336 | −0.0406 | −0.0372 | −0.0376 | −0.0302 | −0.0206 |
| 0 | −0.0064 | −0.0098 | −0.0184 | −0.039 | −0.054 | −0.0576 | −0.0598 |
| −5 | −0.0006 | −0.0006 | 0 | −0.005 | −0.0238 | −0.0536 | −0.056 |
| −10 | −0.004 | −0.003 | −0.0052 | −0.0082 | −0.0222 | −0.0378 | −0.0458 |
| −15 | −0.011 | −0.0136 | −0.014 | −0.0258 | −0.0288 | −0.0382 | −0.04 |

TABLE 40A
Slopes for base curve 4.50 diopters and optical add power 2.00
(0≦x≦30)

| | 0 | 5 | 10 | 15 | 20 | 25 | 30 |
|---|---|---|---|---|---|---|---|
| 10 | −0.0074 | −0.007 | −0.0094 | −0.0148 | −0.0208 | −0.0224 | −0.0238 |
| 5 | −0.0434 | −0.0392 | −0.0568 | −0.0654 | −0.075 | −0.0904 | −0.103 |
| 0 | −0.086 | −0.0804 | −0.0782 | −0.0818 | −0.094 | −0.1072 | −0.1166 |
| −5 | −0.0944 | −0.0922 | −0.0366 | 0.016 | 0.0326 | 0.0296 | 0.0296 |
| −10 | −0.0842 | −0.0864 | −0.0138 | 0.0462 | 0.0978 | 0.1014 | 0.0724 |
| −15 | −0.0732 | −0.0832 | −0.0734 | −0.0204 | 0.0536 | 0.0932 | 0.128 |

TABLE 40B
Slopes for base curve 4.50 diopters and optical add power 2.00
(−30≦x≦0)

| | −30 | −25 | −20 | −15 | −10 | −5 | 0 |
|---|---|---|---|---|---|---|---|
| 10 | −0.036 | −0.021 | −0.025 | −0.0446 | −0.0266 | −0.0146 | −0.0074 |
| 5 | −0.06 | −0.0756 | −0.0664 | −0.0636 | −0.0574 | −0.044 | −0.0434 |
| 0 | −0.0122 | −0.0192 | −0.0422 | −0.0738 | −0.096 | −0.0968 | −0.086 |
| −5 | −0.0026 | −0.0008 | −0.0002 | −0.0092 | −0.0422 | −0.093 | −0.0944 |
| −10 | −0.0036 | −0.003 | −0.0066 | −0.0192 | −0.0468 | −0.081 | −0.0842 |
| −15 | −0.0556 | −0.0614 | −0.0604 | −0.061 | −0.059 | −0.0652 | −0.0732 |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A progressive addition lens device, comprising: a lens body formed with a progressive power surface having a temporal part and a nasal part, and being characterized by an optical power map having a plurality of contours corresponding to transitions between optical powers across said surface,
wherein at least one contour is substantially monotonic across the entire progressive power surface, but has an inflection point at a meridian between said nasal part and said temporal part.

2. The device according to claim 1, wherein all contours above a horizontal line passing 15 mm below a central horizontal line of said map are substantially monotonic at said temporal part.

3. The device according to claim 1, wherein at least some contours are non-monotonic at said nasal part.

4. The device according to claim 1, wherein at least some contours above a horizontal line passing 15 mm below a central horizontal line of said map are non-monotonic at said nasal part.

5. The device according to claim 1, wherein at least 70% of said contours are substantially monotonic at said temporal part.

6. The device according to claim 1, wherein all contours at a polar coordinate φ from about 0°−Δφ to about 0°+Δφ within said temporal part are substantially monotonic, wherein Δφ is at least 60 degrees and φ is defined with respect to a central horizontal line of said lens body such that φ=0° is at said temporal part.

7. The device according to claim 1, wherein an angular span for which all the contours are substantially monotonic at said nasal part is of less than 40 degrees.

8. The device according to claim 1, wherein said optical power map is asymmetric in a near-viewing zone of said map and in a far-viewing zone of said map.

9. The device according to claim 1, wherein said optical power map is characterized by an asymmetry matrix having a plurality of entries each representing a difference in optical powers for an antipodal pair residing symmetrically at both sides of a main meridian of said lens body such that the location of each point is a minor image of the location of the other point about said meridian line, and wherein said asymmetry matrix has at least one entry which is above one third of an optical add power of the lens device.

10. The device according to claim 9, wherein said asymmetry matrix has at least one far-viewing zone entry which is are above one fifth of said optical add power.

11. The device according to claim 1, wherein a variation of said optical power as a function of a horizontal coordinate x is substantially monotonic at said temporal part, but exhibits at least one local minimum at said nasal part.

12. (canceled)

13. (canceled)

14. The device according to claim 1, wherein a variation of said optical power as a function of a vertical coordinate y is substantially monotonic at said temporal part, but exhibits at least one local maximum at said nasal part.

15. The device according to claim 1, being characterized by a cylinder value map which is asymmetric with respect to a main meridian of said cylinder value map.

16. The device according to claim 1, wherein at least several far viewing locations over said temporal part are characterized by a cylinder value which is at least 50% of an optical add power of the device.

17. A progressive addition lens device, comprising:
a lens body formed with a progressive power surface having a temporal part and a nasal part situated at both sides of a main meridian,
said progressive power surface being characterized by an optical power map which is asymmetric with respect to said main meridian both in a near-viewing zone and in a far-viewing zone of said lens body.

18-21. (canceled)

22. A mold device for forming a progressive addition lens device, comprising a mold body shaped complementarily to the lens body according to claim 1.

23-26. (canceled)

27. A method of optimizing a progressive power surface characterized by an initial optical power map, comprising:
virtually dividing said surface to domains; and
for at least one of said domains processing cylinder values over said domain so as to optimize an objective function defined over said domain;
thereby optimizing the progressive power surface.

28. The method according to claim 27, wherein said objective function comprises a sum of cylinder values over said domain.

29. The method according to claim 28, wherein said sum is a weighted sum featuring a weight function.

30. The method according to claim 29, further comprising updating said weight function and repeating at least one of said dividing and said processing using said updated weight function.

31. (canceled)

32. (canceled)
